(19) United States
(12) Patent Application Publication
(10) Pub. No.: US 2025/0356657 A1
(43) Pub. Date: Nov. 20, 2025

(54) ASSISTIVE TRANSFER PERFORMANCE ASSESSMENT SYSTEM AND METHOD

(71) Applicant: Georgia Tech Research Corporation, Atlanta, GA (US)

(72) Inventors: Brian Jones, Atlanta, GA (US); Peter Presti, Atlanta, GA (US); Jon Sanford, Atlanta, GA (US); Su Jin Lee, Atlanta, GA (US); Russell Taylor, Atlanta, GA (US); Avinandan Basu, Alanta, GA (US); Shivakani Pandey, Lynn, MA (US)

(21) Appl. No.: 19/209,016

(22) Filed: May 15, 2025

Related U.S. Application Data
(60) Provisional application No. 63/648,139, filed on May 15, 2024.

(51) Int. Cl. G06V 20/52; A61G 7/10; G06V 20/00

(52) U.S. Cl. CPC G06V 20/52; A61G 7/1001; G06V 20/36; G06V 2201/07

(57) ABSTRACT

An assessment system and method for assessing transfer performance within a bathroom environment that includes an assistive device located in the bathroom environment that is configured to assist an individual with toilet or bathing transfer where the assistive device is configured to be adjustable within the bathroom environment. Sensors associated with the assistive device are configured to measure and collect sensor data during stages of the toilet or bathing transfer by the individual using the at least one assistive device within the bathroom environment, wherein the sensor data represents one or more aspects of transfer performance of the individual. A control module that has an assistive technology computing device communicatively coupled with the one or more sensors can receive the sensor data from the one or more sensors, and assess a transfer performance of the individual based on the sensor data.

### CROSS-REFERENCE TO RELATED APPLICATION

This application claims the benefit of priority of U.S. Provisional Application Ser. No. 63/648,139 filed on May 15, 2024 and entitled “Toilet and Bathing Transfer Assessment System,” the content of which is relied upon and incorporated herein by reference in its entirety.

### STATEMENT REGARDING FEDERALLY SPONSORED RESEARCH OR DEVELOPMENT

This invention was made with government support under 90RE5016-04-01 and 90REGE006-01-00 awarded by DHHS/PHS/ADMINISTRATION FOR COMMUNITY LIVING (ACL)/WASHINGTON, DC. The government has certain rights in the invention.

### BACKGROUND

The present disclosure relates to assistive transfer performance assessment systems and methods, such as during toilet and bathing transfers.

Individuals' functional abilities change over time, increasing and decreasing over their lifespan. For some, functional abilities may fluctuate over the course of a day. While these fluctuations may not impact one's ability to engage in daily activities, they can be problematic for people aging with disability or a progressive chronic condition such as arthritis or multiple sclerosis, particularly when performing toilet or shower/bath transfers. Although various assistive technologies (AT) and environmental modifications are designed to facilitate bathroom transfers, they are static solutions, selected to match an individual's ability at one point in time rather than providing a dynamic environment that can adapt to support changing abilities.

Current technologies, such as fixed grab bars, are intended to compensate for physical barriers to transfer in the bathroom. However, many of these solutions have been designed primarily for young wheelchair users with significant upper body strength and whose abilities are more stable. Individuals with progressive chronic conditions may lack such strength due to varying functional abilities. For example, individuals with MS may experience days or weeks of reduced mobility before returning to baseline. Currently, available AT for bathroom transfer only meets these needs some of the time.

The design of accessible products and AT (e.g., wall-mounted grab bars, raised toilet, shower seat) have traditionally been designed around young veterans who, despite lower-body impairment, had upper-body strength to transfer to and from a wheelchair. However, the demographics of people with disabilities have changed dramatically. The American population is living longer, and more people are aging with disabilities exacerbated by age-related frailty and chronic conditions (e.g., arthritis) that limit upper body strength and range of motion. Thus, existing technologies do not compensate for the range of conditions and co-morbidities common among older adults. Further, standard AT and accessible designs may do more to exacerbate disability among older adults than to ameliorate it.

### SUMMARY

An assessment system that is configured to assess transfer performance within a bathroom environment. The assessment system may comprise at least one assistive device located in the bathroom environment that is configured to assist an individual with toilet or bathing transfer in the bathroom environment. The at least one assistive device can be configured to be adjustable and/or movable within the bathroom environment. One or more sensors associated with the at least one assistive device can be configured to measure and collect sensor data during stages of toilet or bathing transfer by the individual using the at least one assistive device within the bathroom environment. The sensor data may represent one or more aspects of transfer performance of the individual. A control module that comprises an assistive technology computing device communicatively coupled with the one or more sensors, can be programmed to: receive the sensor data from the one or more sensors, and assess a transfer performance of the individual based on the sensor data. The control module can be programmed to determine a recommended adjustment in connection with the at least one assistive device and the bathroom environment based on the transfer performance of the individual assessed by the control module, the recommended adjustment being one or both of: (a) adjusting a position of the at least one assistive device by moving the at least one assistive device from a first position in the bathroom environment to a second position in the bathroom environment, or (b) adding another assistive device to the bathroom environment.

In some aspects, the assessment system may further comprise one or more of a toilet transfer system, a bathing transfer system, and a floor transfer system under the toilet and bathing transfer systems, and each of the toilet transfer system, the bathing transfer system, and the floor transfer system comprising a sensor of the one or more sensors; the one or more sensors are configured to measure one or more forces applied to the at least one assistive device by the individual; the one or more aspects of transfer performance represented by the sensor data comprises one or more of gait, stability, location, movement, grip force, and grip type of the individual.

In certain aspects, the one or more sensors may comprise one or more of a load cell, a force sensing resistor, a capacitive sensor, a motion sensor, a touch sensor, a camera linear potentiometer, location sensors, pressure mapping sensor, presence sensor, camera depth sensor, radar speed sensor, depth sensor, radar 3D imaging sensor, multi-camera depth sensor, and stereo depth sensor; the one or more sensors are embedded in the at least one assistive device; the at least one assistive device comprises an adjustable grab bar, the adjustable grab bar being configured to slide between the first position and the second position in the bathroom environment; the at least one assistive device comprises an adjustable toilet that is configured to be raised and lowered when moving from the first position to the second position or from the second position to the first position; and/or the recommended adjustment comprises a height adjustment of the at least one assistive device.

In other aspects, the at least one assistive device comprises a plurality of assistive devices, each of the assistive devices of the plurality of assistive devices comprise at least one of the one or more sensors; and/or the plurality of assistive devices comprises two or more of a grab bar, a movable toilet, a toilet seat, a bath tub, a shower seat, or a wall.

An adjustable bathroom environment that comprises at least one assistive device configured to assist an individual with toilet or bathing transfer in a bathroom environment. The at least one assistive device is configured to be movable within the bathroom environment. The adjustable bathroom environment also comprising one or more of a toilet transfer system, a bathing transfer system, and a floor transfer system under the toilet and bathing transfer systems. Each of the toilet transfer system, the bathing transfer system, and the floor transfer system can comprise one or more sensors. The one or more sensors can be configured to measure and collect sensor data during stages of toilet or bathing transfer by the individual using the at least one assistive device, wherein the sensor data represents one or more aspects of transfer performance of the individual. A control module may comprise an assistive technology computing device communicatively coupled with the one or more sensors, wherein the control module can be programmed with computer readable instructions that, when executed, can cause the control module to: receive the sensor data from the one or more sensors, assess a transfer performance of the individual based on the sensor data, and provide a recommended adjustment in connection with the at least one assistive device needed for the bathroom environment based on the transfer performance of the individual assessed by the control module, the recommended adjustment being one or both of: (a) adjusting a position of the at least one assistive device by moving the at least one assistive device from a first position in the bathroom environment to a second position in the bathroom environment, or (b) adding another assistive device to the bathroom environment.

In some aspects, the control module can be located outside of the adjustable bathroom environment, and the control module can be in wireless communication with the one or more sensors; and/or the control module can be in communication with a user's device which is in communication with the one or more sensors.

In other aspects, the at least one assistive device comprises a grab bar, a movable toilet, a toilet seat, a bath tub, a shower seat, or a wall; and the one or more sensors comprise one or more of a load cell, a force sensing resistor, a capacitive sensor, a motion sensor, a touch sensor, a camera linear potentiometer, location sensors, pressure mapping sensor, presence sensor, camera depth sensor, radar speed sensor, depth sensor, radar 3D imaging sensor, multi-camera depth sensor, and stereo depth sensor.

A method for assessing transfer performance of an individual in a bathroom environment, that comprises collecting sensor data associated with at least one assistive device in the bathroom environment during stages of toilet or bathing transfer by the individual in the bathroom environment, wherein the sensor data represents one or more aspects of transfer performance of the individual; transmitting the sensor data to a control module comprising an assistive technology computing device, the control module being programmed with computer readable instructions that, when executed, cause the control module to assess a transfer performance of the individual based on the sensor data and recommend an adjustment in connection with the at least one assistive device needed for the bathroom environment based on the transfer performance of the individual assessed by the control module; and based the adjustment recommended by the control module, either or both of: (a) adjusting a position of the at least one assistive device by moving the at least one assistive device from a first position in the bathroom environment to a second position in the bathroom environment, or (b) adding another assistive device to the bathroom environment.

In certain aspects, the at least one assistive device comprises a grab bar, a movable toilet, a toilet seat, a bath tub, a shower seat, or a wall; one or more sensors are associated with the at least one assistive device, and the one or more sensors are configured to measure and collect the sensor data; the one or more sensors comprise one or more of a load cell, a force sensing resistor, a capacitive sensor, a motion sensor, a touch sensor, a camera linear potentiometer, location sensors, pressure mapping sensor, presence sensor, camera depth sensor, radar speed sensor, depth sensor, radar 3D imaging sensor, multi-camera depth sensor, and stereo depth sensor; and/or the one or more aspects of transfer performance represented by the sensor data comprises one or more of gait, stability, location, movement, grip force, and grip type of the individual.

This summary is not intended to identify essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE DRAWINGS

For a detailed description of various examples, reference will now be made to the accompanying drawings in which:

FIGS. 1A-1D show various parts of an exemplary layout of a bathroom environment in accordance with one or more embodiments.

FIG. 2 shows, in block diagram form, a simplified network diagram in accordance with one or more embodiments.

FIG. 3 shows, in flowchart form, an exemplary implementation of a method within a bathroom environment in accordance with one or more embodiments.

FIG. 4 shows an exemplary layout of the bathroom environment in accordance with one or more embodiments.

FIG. 5 shows, in block diagram form, an exemplary system diagram for a computing device associated in accordance with one or more embodiments

FIG. 6A shows a diagram of exemplary bathroom environment system architecture and data transfer components in accordance with one or more embodiments.

FIG. 6B shows exemplary components of a toilet transfer performance assessment of the system in accordance with one or more embodiments.

FIG. 7 shows an exemplary view showing a smart floor of the bathroom environment extending under a toilet and into a shower/bathing area in accordance with one or more embodiments.

FIGS. 8A-8E shows an exemplary layout of a smart floor in accordance with one or more embodiments.

FIG. 9 shows exemplary views of the smart floor in accordance with one or more embodiments.

FIG. 10A shows an exemplary 12-channel differential ADC and FIG. 10B shows a visualization of smart floor pressure data overlaid on a floor diagram, in accordance with one or more embodiments.

FIG. 11 shows an exemplary view of a smart toilet in accordance with one or more embodiments.

FIG. 12 shows an exemplary images of load cells on an augmented toilet seat and rendering of the load cell locations from a top view in accordance with one or more embodiments.

FIG. 13 shows an exemplary full data wave forms of four loads on a smart seat in accordance with one or more embodiments.

FIG. 14 shows an exemplary view of data output of an augmented seat based on load cell locations in accordance with one or more embodiments.

FIG. 15 shows exemplary views closeup of a bar showing 3D printed insert and the embedding of the sensors into the insert to ensure wires were out of the way for gripping in accordance with one or more embodiments.

FIG. 16 shows an exemplary view of modifications to a bar including drilling to allow sensor wiring to tunnel under adjacent sensors where the 3D printed insert is replaced with a rubberized insert and provided with a flat surface for the sensors to improve sensor reliability in accordance with one or more embodiments.

FIG. 17 shows exemplary time plots of the grab bar sensors showing load cells, side and bottom FSRs, FSLP top position and top pressure sensors in accordance with one or more embodiments.

FIG. 18 shows exemplary renderings of a custom mount design to isolate movement of the grab bar from the toilet frame, thus allowing accurate force measures in accordance with one or more embodiments.

FIG. 19 shows an exemplary mount without the grab bar attached, showing the load cell configuration alongside the mount with grab bar attached and sensing components in accordance with one or more embodiments.

FIG. 20 shows an exemplary side view of the mount and mechanism for manually modifying the horizontal position in accordance with one or more embodiments.

FIG. 21A shows an exemplary rendering of the grab bar sensors; and FIG. 21B shows an exemplary raw waveforms from the load cells when the grab bar is used in accordance with one or more embodiments.

FIG. 22 shows an exemplary smart bathing transfer system including a tub cradle that holds a bathtub and grab bars that are either vertically adjustable (long-side) or are flexibly adjustable (short-ends) where the tub cradle can be lifted to the ceiling with a motor and drive system in accordance with one or more embodiments.

FIG. 23 shows an exemplary view of bathtub grab bars in accordance with one or more embodiments.

FIG. 24 shows an exemplary view of grab bars at the ends of the tub that are designed to allow flexible positioning vertically, horizontally, and to any angle in accordance with one or more embodiments.

FIG. 25 shows views an exemplary grab bar sensing mechanism in accordance with one or more embodiments.

FIGS. 26A and 26B show an exemplary grab bar and bathing grab bar diagrams showing examples of different sensors that can be used with the grab bar in accordance with one or more embodiments.

FIG. 27 shows exemplary plots of sensing outputs in accordance with one or more embodiments.

FIG. 28 shows exemplary views of a synchronized video ground truth recording system in accordance with one or more embodiments.

FIG. 29 shows additional exemplary views of a synchronized video ground truth recording system in accordance with one or more embodiments.

FIG. 30 shows exemplary components of a synchronized video ground truth recording system in accordance with one or more embodiments.

FIG. 31 shows additional exemplary views of a synchronized video ground truth recording system in accordance with one or more embodiments.

FIG. 32 shows an exemplary event control application for controlling and monitoring sensor streams in accordance with one or more embodiments.

FIG. 33 shows an exemplary data export tool in accordance with one or more embodiments.

FIG. 34 shows an exemplary visualization of a smart seat showing greater pressure through deeper colors of the circles where value are provided beside each sensor circle in accordance with one or more embodiments.

FIG. 35 shows an exemplary toilet grab bar visualization showing values of load cells near the mount where the black dot at the bottom of the mount is the offset from center of the centroid of force and false-coloring on the long rectangles is the force on the FSRs and top rectangle in accordance with one or more embodiments.

### DETAILED DESCRIPTION

Disclosed herein are systems and methods directed to assessing transfer performance to inform adjustment or moving of components of assistive equipment within an environment, such as a bathroom environment, based on the assessment of transfer performance. The bathroom environment can be any bathroom space, such as in a residential home, community facility, public or commercial building, and the like. The bathroom environment can also be a simulated bathroom space, such as in a laboratory or testing environment. Assistive equipment may include any assistive technology device, such as wall-mounted grab bars, a raised or adjustable toilet, a shower seat, or the like. The term “transfer” refers to the process of moving from one surface to another, such as from a wheelchair to a toilet, from a standing position to a toilet, or from a toilet to a standing position. Transfers can vary in complexity and may require different levels of assistance, including manual help from a caregiver or therapist. Current assistive technologies (AT) are static solutions, selected to match an individual's ability at one point in time only rather than providing a dynamic environment that can adapt to support changing abilities. The present disclosure may provide flexible solutions that can adapt to an individual's current ability that may allow greater success in transfer.

It is to be understood that the figures and descriptions of the present disclosure may have been simplified to illustrate elements that are relevant for a clear understanding of the present disclosure, while eliminating, for purposes of clarity, other elements found in known assistive technology. Those of ordinary skill in the art will recognize that other elements may be desirable and/or required in order to implement the present disclosure. However, because such elements are well known in the art, and because they do not facilitate a better understanding of the present disclosure, a discussion of such elements is not provided herein. It is also to be understood that the drawings included herewith only provide diagrammatic representations of the presently preferred structures of the present disclosure and that structures falling within the scope of the present disclosure may include structures different than those shown in the drawings. Reference will now be made to the drawings wherein like structures are provided with like reference designations.

Before explaining at least one embodiment in detail, it should be understood that the inventive concepts set forth herein are not limited in their application to the construction details or component arrangements set forth in the following description or illustrated in the drawings. It should also be understood that the phraseology and terminology employed herein are merely for descriptive purposes and should not be considered limiting.

It should further be understood that any one of the described features may be used separately or in combination with other features. Other invented devices, systems, methods, features, and advantages will be or become apparent to one with skill in the art upon examining the drawings and the detailed description herein. It is intended that all such additional devices, systems, methods, features, and advantages be protected by the accompanying claims.

The present disclosure provides an assessment system and method that is configured to assess transfer performance within a bathroom environment. The assessment system may comprise at least one assistive device located in the bathroom environment that is configured to assist an individual with toilet or bathing transfer in the bathroom environment. The at least one assistive device can be configured to be adjustable and/or movable within the bathroom environment. One or more sensors associated with the at least one assistive device can be configured to measure and collect sensor data during stages of toilet or bathing transfer by the individual using the at least one assistive device within the bathroom environment. The sensor data may represent one or more aspects of transfer performance of the individual. A control module that comprises an assistive technology computing device communicatively coupled with the one or more sensors, can be programmed to: receive the sensor data from the one or more sensors, and assess a transfer performance of the individual based on the sensor data. The control module can be programmed to determine a recommended adjustment in connection with the at least one assistive device and the bathroom environment based on the transfer performance of the individual assessed by the control module, the recommended adjustment being one or both of: (a) adjusting a position of the at least one assistive device by moving the at least one assistive device from a first position in the bathroom environment to a second position in the bathroom environment, or (b) adding another assistive device to the bathroom environment.

Applications of the disclosed assessment system and method may include, for example (1) Bathroom Transfer Measurement and Assessment System: Performing measurement and assessment of individual transfer performance for the purpose of research, training, or healthcare practice. The system may be used in whole or in part for this purpose in a classroom, research lab, healthcare facility or senior living community organization and be performed by educators, occupational therapists (OTs) or similar healthcare professions, or senior living community staff; (2) Smart Health System for Monitoring Changing Physical Ability: Monitoring and automatic assessment of transfer performance longitudinally in a home, senior living community, or similar for the purpose of adjusting transfer environments, detecting changes in individual physical abilities, or personal awareness. This monitoring may be initiated by an OT or similar healthcare professional, senior living community staff, consumer caregiver or end; (3) System/Service for Evaluation of Commercial Bathroom Fixtures: Evaluating commercial products intended for supporting bathroom transfers in a home environment, healthcare office environment, senior living community setting, or similar setting. This would be a service provided by researchers or product testing experts, for example; and (4) Automated Bathroom Transfer Assistance System: adjusting bathroom fixtures in common bathrooms or personal bathrooms in senior living community, healthcare facility, business, or home based on individual preferences. Fixture adjustments may be informed through longitudinal sensing of changing needs, for example in a home setting, where users abilities may change during the course of the day or longer term. Preferences in other settings may be based on past trends.

In some embodiments of the present disclosure, a highly sensed, adjustable residential bathroom environment accommodates task performance during bathroom transfers. The present disclosure can identify, for example, problems faced by individuals with functional limitations as they age as well as exploring viable solutions to these problems. Additionally, the present disclosure can address design and engineering requirements, challenges, and choices in developing an adjustable bathroom environment.

In an embodiment of the present disclosure, systems and methods are provided to understand, assess, and improve on design in the bathroom to reduce barriers to transfers experienced by individuals, such as those with limited mobility (e.g., older adults), particularly for those with functional impairments.

In some embodiments of the present disclosure, systems and methods are provided to investigate and assess how individuals with a variety of functional abilities perform bathroom transfers and the interactions between design and ability. The system can 1) document weight distribution, posture, and other biomechanical evaluations during unassisted and caregiver-assisted trails; 2) predict needs for physical support during bathroom activities based on biomechanical measures; 3) consider the efficacy of prompts that encourage safe practices to avoid falls during bathroom transfers; and 4) develop methods for manual or automated fixture adjustments.

In an embodiment, an exemplary environment may be created where a typical home bathroom may be used as a core component of a larger aware home sensing infrastructure. Within the exemplary environment, a more holistic understanding of an individual's current abilities may be obtained. The exemplary environment can consider parameters of transfer, solutions to measure those parameters, and scaling the system to an aware home environment is realized.

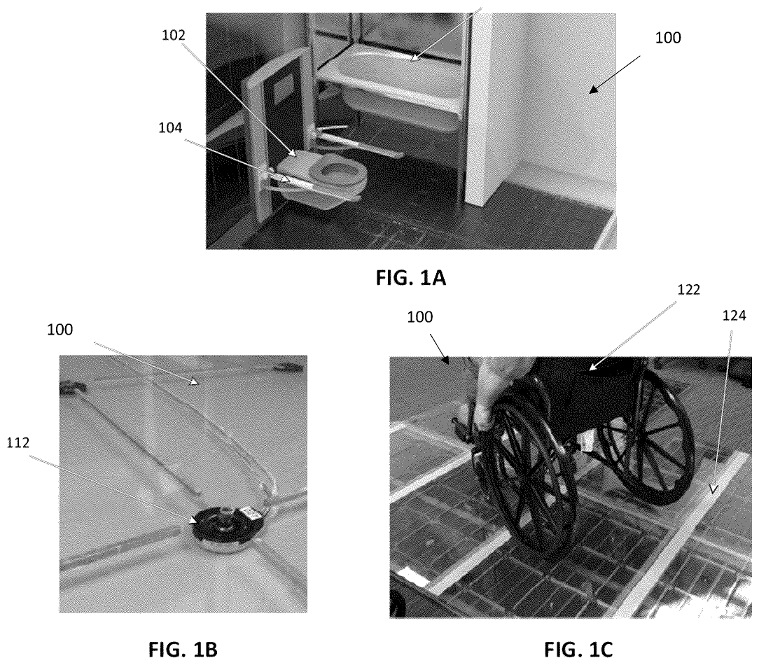

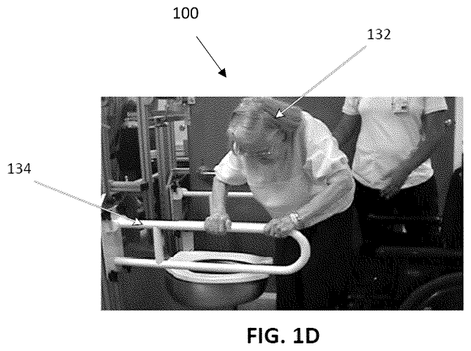

FIG. 1A illustrates exemplary assistive devices of the bathroom environment 100 that may include a motorized toilet 102, bilateral toilet grab bars 104, and a bathtub 106 on a lift. FIG. 1B illustrates a close-up of an exemplary sensor 112, such as a load cell, disposed in a smart floor 124 of the bathroom environment. FIG. 1C illustrates a testing wheelchair 122 on the smart floor 124 of the bathroom environment. FIG. 1D illustrates an example of an individual 132 performing a transfer, namely a toilet transfer using bilateral grab bars 134.

In one exemplary embodiment of the present disclosure, older adults with functional impairments who were able to ambulate to transfer were studied. Activities included, for example, toilet, shower, and bathtub transfers. Design requirements were created for the physical environment, fixtures, and technology components. Additionally, flexibility in design was a consideration in view of constraints of the bathroom environment.

Continuing with the example, as shown in FIG. 1A, the toilet 102 can be configured to move vertically to improve transfer adjustments and horizontally to provide room for AT and caregiver assistance. To make room for an expanded area during toilet transfers and transform the tub 106 into a walk-in shower for usability studies, the adjacent bathtub 106 may be removed. To meet the fluctuating needs of an individual, grab bars 104 or 134 may allow vertical, lateral, and extension adjustments around the toilet 102. In the shower/bath 106, grab bars (not shown) may be provided that are adjustable between multiple positions on the wall as well as for mounting at various angles.

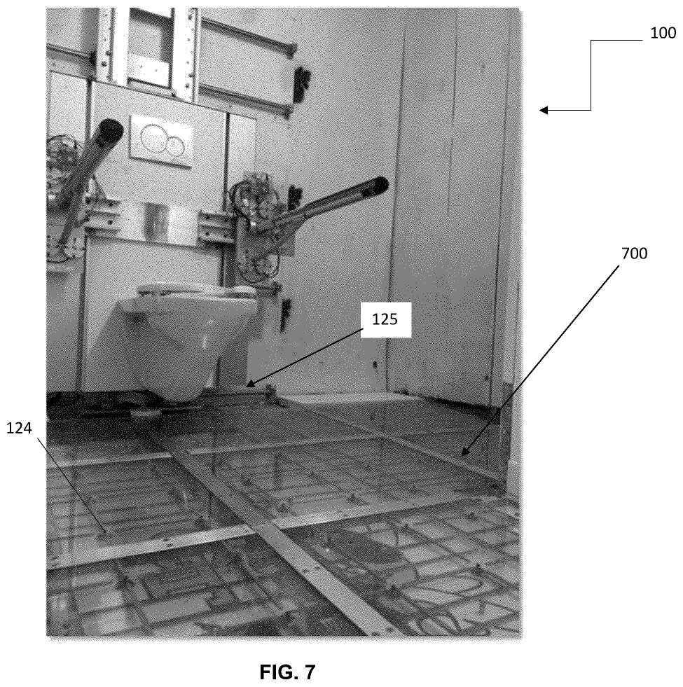

Several options for physical space modifications and bathroom AT fixtures may be selected to meet design requirements and customize for the individual. For example, toilet 102 may be height adjustable and may be used for its vertical adjustability. Additionally, a custom base may be used to support horizontal adjustment of the toilet 102. In an example, the base 125 (FIG. 7) can be under the back of the toilet mechanism with wheels under it that roll on a metal plate on the floor and with bars mounted to the wall that allow slides mounted to the vertical components of the toilet to slide the whole unit horizontally. Also, bilateral grab bars 134 may be used. The bilateral grab bars 134 may, for example, include a 36″ U-shaped wall-mount grab bar and two standard lengths of vertically adjustable grab bars (e.g., 24″ and 36″). A motorized lift can be used for a bath-to-shower conversion capable of suspending a freestanding bathtub from the ceiling and lowering it to a curbless shower floor as needed. Even further, one or more custom shower walls with a grid of mounting points may be installed. The custom grab bars may include one or more quick release pins for adjustable mounting and clamp down.

The present disclosure can provide embedded sensing solutions which may provide real-time objective measures of aspects of transfer performance like weight transferred between floor and fixtures or grip strength used during transfer. By measuring foot movement and weight shift on the floor or the weight exerted on assistive devices, grab bars, toilet seat, walls, and bathtub while also measuring the location, strength, and manner of grip on the bars (e.g., hand and opposing thumb, palming the bar), transfer performance may be objectively gauged and mapped onto video-based posture and limb tracking data. Additionally, assistive devices embedded with pressure sensors, such as grab bars 104 or 134 embedded with pressure sensors, may provide sensing that tracks weight exerted on the bars, grip position on the bars, grip manner, and grip strength on the bars. Additionally, a seat of toilet 102 may be embedded with pressure sensors that can measure weight and weight shifts.

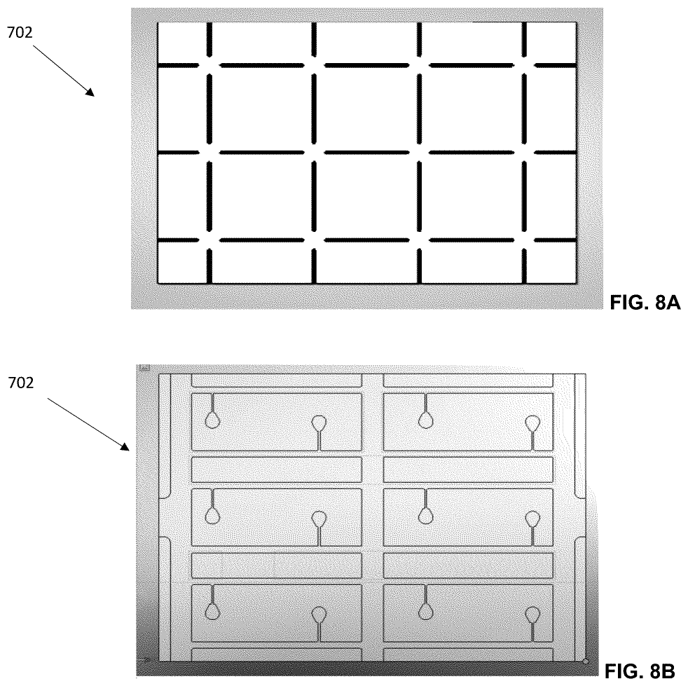

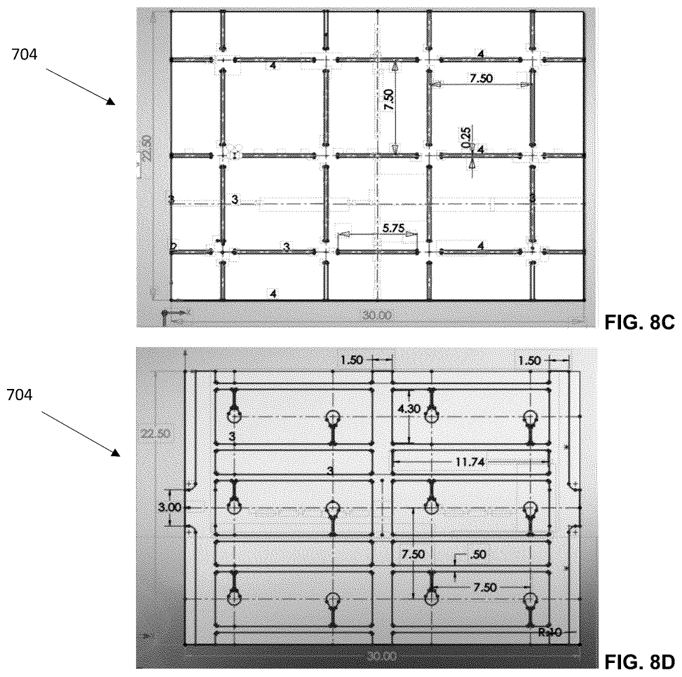

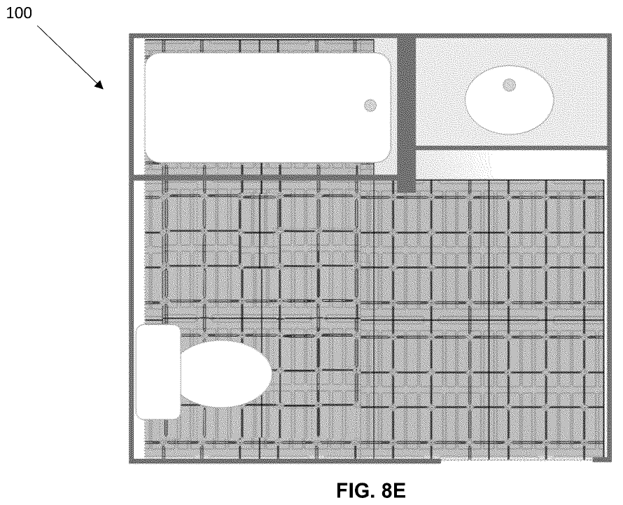

Smart floor 124 may be used to precisely track foot movements, wheelchair movements, weight shifts, or the like. Floor 124 can be pressure sensing via a pressure mapping system and a suspended floor, for example. In an example, the floor 124 may be a modular floor with upper and lower layers comprised of a grid of tiles on piezo-resistive load calls with minimal thickness. In some embodiments, the modular design may be used providing channels or grooves for embedded electronics and wires. In an example, the grid of tiles may, for example, be 8″×8″ tiles. The floor 124 may have different tile/load cell configurations with respect to floor thickness, floor movement, modularity of the design, and ease of replacing sensors and electronics. FIG. 8A illustrates an exemplary grid pattern of tiles of an exemplary upper layer of floor 124 and FIG. 8B illustrates a schematic for CNC routing of the upper layer. Fasteners, such as hex set screws, can be inserted at the center of the intersections of the grid. FIG. 8C also illustrates sensor, e.g. load cell, and channel layout for the lower layer, and FIG. 8D illustrates a schematic for CNC routing of the lower layer. In this example, the grooves or channels may be cut into the upper layer to form tile-like sections with setscrews at tile corners to concentrate the force on the load cells inset in the lower panel. FIG. 8E illustrates an exemplary layout of floor 124 for the bathroom environment 100 including 10 modular panels.

In some embodiments, a grip detection system may be provided. In this example, one or more of the grab bars 104 or 134 may be embedded at one or more locations with one or more sensors, such as force sensors. For example, short (e.g. 4 inch) combined force-position sensors may be embedded on the top of the grab bar (i.e., where hands are likely to grip) for detecting multiple hands, grip location and force. Additionally, or alternatively force sensors spanning the full length of the grab bar may be embedded for measuring grip force on the sides and bottom of the grab bars. In some embodiments, an insert, or channel, may be created within the grab bar to attach sensors to improve sensor accuracy, protect sensor connections, and hide sensor wires. The weight measurement system may be designed to measure force in all directions, similar to a joystick. In some embodiments, configuration may include four-single-axis traditional load cells at the corners of an aluminum rectangle positioned between the sliding mount of a grab bar and the grab bar itself so that the bars may be adjusted without reducing measurement accuracy.

Basic or default settings of bathroom environment 100 may be obtained through trials of transfers in normative populations. Additionally, basic or default settings may be refined based on how target populations perform in the bathroom environment 100. A variety of variables may be focused on, such as fatigue and other measurable parameters (e.g., gait speed). Additionally, predictive algorithms may use these parameters to determine when and how bathroom configurations and manual or automated adjustments may improve transfer performance for the individual. For example, an AI-trained model may be used to assess transfer performance and predict adjustments and/or modifications needed for the configuration bathroom environment 100 based on the individual's task performance data. Adjustments and/or modifications may include, for example, height adjustment of equipment (e.g., grab bars, toilet seat), addition of new safety features or devices (e.g., additional grab bars), automated adjustment of safety features, or the like.

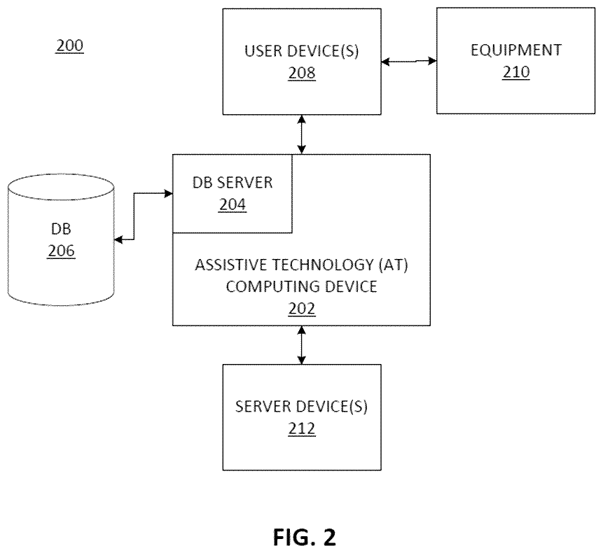

FIG. 2 depicts an exemplary control module 200 operatively associated with assistive technology (AT) for the bathroom environment. Control module 200 may include an AT computing device 202. AT computing device 202 may include a database server 204 that may be communicatively coupled to a database 206 that stores data. In one embodiment, database 206 may be a local storage device. In another embodiment, database 206 may be a remote storage device, such as cloud storage, or the like. AT computing device 202 may be in communication with a plurality of user device(s) 208. User device(s) may be connected to AT equipment 210 (such as grab bars 104 or 134). Further, AT computing device 202 may be in communication with a plurality of server device(s) 212. In some embodiments, server device(s) 212 may be associated with, for example, a remote server that provides assistive technology services. In some embodiments, assistive technology services may be performed by AT computing device 202, server device(s) 212, or a combination thereof. Additionally, or alternatively, assistive technology may be performed on user device(s) 208. The control module 200 may be used for automatically moving components (e.g., toilet and grab bars vertically and horizontally) to allow personalization of the system to match and eventually adapt to an individual's changing needs.

In the exemplary embodiment, user device(s) 208 may be computers that include a web browser or a software application, which enable user device(s) 208 to access remote computer devices, such as AT computing device 202, using the Internet or another network. More specifically, user device(s) 208 may be communicatively coupled to AT computing device 202 through many interfaces including, but not limited to, at least one of the Internet, a network, a local area network (LAN), a wide area network (WAN), a cellular phone connection, a cable modem, or the like. User device(s) 208 may be any device capable of accessing the Internet including, but not limited to, a desktop computer, a laptop computer, a personal digital assistant (PDA), a cellular phone, a smartphone, a tablet, wearable electronics, smart watch, or other web-based connectable equipment or mobile devices. AT computing device 202 may receive sensor data (e.g., pressure sensor data) from sensors associated with AT equipment 210 via user device(s) 208. Further, AT computing device 202 may securely store the collected user data on database 206.

In the exemplary embodiment, server device(s) 212 may be computers that include a web browser or a software application, which enable server device(s) 212 to access remote computer devices, such as AT computing device 202, using the Internet or another network. More specifically, server device(s) 212 may be communicatively coupled to AT computing device 202 through many interfaces including, but not limited to, at least one of the Internet, a network, a local area network (LAN), a wide area network (WAN), a cellular phone connection, a cable modem, or the like. Server device(s) 212 may be any device capable of accessing the Internet including, but not limited to, a desktop computer, a laptop computer, a personal digital assistant (PDA), a cellular phone, a smartphone, a tablet, wearable electronics, smart watch, or other web-based connectable equipment or mobile devices.

Server device(s) 212 may be communicatively coupled with AT computing device 202. In some embodiments, server device(s) 212 may serve as an intermediary between AT computing device 202 and a third-party server (not shown). Server device(s) 212 may be used to provide assistive technology services to users, such as respective users of user device(s) 208. For example, AT computing device 202 may receive sensor data from equipment 210 via user device(s) 208 that is to be processed and analyzed. AT computing device 202 may provide the sensor data received to a computing module, and may use server device(s) 212 to process the data, or AT computing device 202 and server device(s) 212 may work together to process the data.

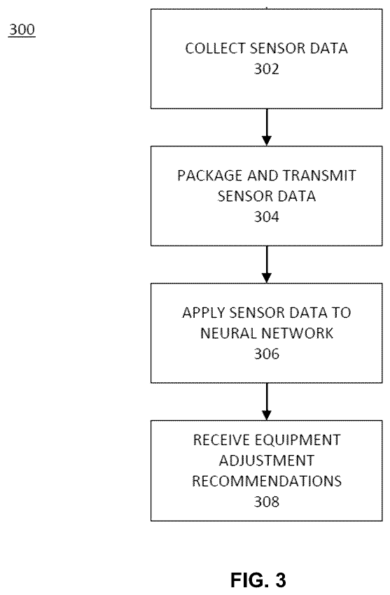

FIG. 3 depicts an exemplary method 300 of the present disclosure. Method 300 may be performed by AT computing device 202 (shown in FIG. 2). Further, steps of method 300 may be performed in conjunction with user device(s) 208, equipment 210, and server device(s) 212, as shown in the exemplary configuration illustrated in FIG. 2.

Method 300 may include measuring and collecting 302 sensor data during the stages of ambulating toilet and bathing transfer. Collected sensor data may represent aspects of performance during the stages of ambulating toilet and bathing transfer. Sensor data may be obtained from one or more sensors embedded within assistive technology devices of bathroom environment 100. For example, sensors embedded within one or more grab bars 104 or 134 can measure or infer gait, stability, location, movement, grip force, grip type, or the like.

Method 300 may include packaging and transmitting 304 sensor data. For example, sensor data may be collected by a device local to the bathroom environment 100, such as user device 208, and transmitted to a remote device, such as AT computing device 202 or server device(s) 212, for additional processing.

Method 300 may include applying 306 the sensor data to a computing module, e.g. a neural network, of computing device 202. The neural network may, for example, include a trained model using artificial intelligence/machine learning (AI/ML) techniques to assess an individual's transfer performance and predict an individual's future needs. For example, the AI/ML trained model may, in some cases, track the individual's task performance within the bathroom environment 100 over a period of time. Based on this, the AI/ML trained model may provide recommendations catered to the individual's needs (e.g., modify or adjust safety equipment, automate safety equipment movement, install or uninstall safety equipment).

Method 300 may include receiving 308 equipment adjustment recommendations. Recommendations may be provided to, for example, a user device associated with the individual, a caregiver of the individual, a medical provider, or a combination thereof. Based on the recommendations received, the configuration of the AT equipment 210 can be adjusted or moved, and/or additional AT equipment can be added to the bathroom environment.

In some embodiments, the AI/ML trained model may detect changing bathroom transfer needs of individuals with disabilities in home and shared residential settings with expected innovations related to automation of bathroom fixtures to adjust based on longitudinally measured data and intelligent algorithms. Multiple systems may be used to measure task performance of an individual including, for example, a toilet transfer system, a bathing transfer system, and a floor system under the toilet and bathing transfer systems. Each of the components may be embedded with environmental sensing capable of measuring important aspects of transfer performance, including forces applied to fixtures. The environmental sensing may be capable of inferring gait, stability, location, movement, grip force, and grip type.

In some embodiments, the system may include image/video capture systems and software components to record study performance for later observational review. The image/video capture systems and software components may be used to control the capture of data by the system, the visualization of data, management of data, and archiving of the data. The image/video capture systems may include one or more video cameras and other motion sensors (e.g., Microsoft Kinect®) for capturing high-level toilet and bathtub/shower transfer task performance. The video camera(s) and motion sensor(s) may provide data to conduct a visual assessment of key aspects of transfer including posture, position of hands/grip, limbs, overall task performance, or the like.

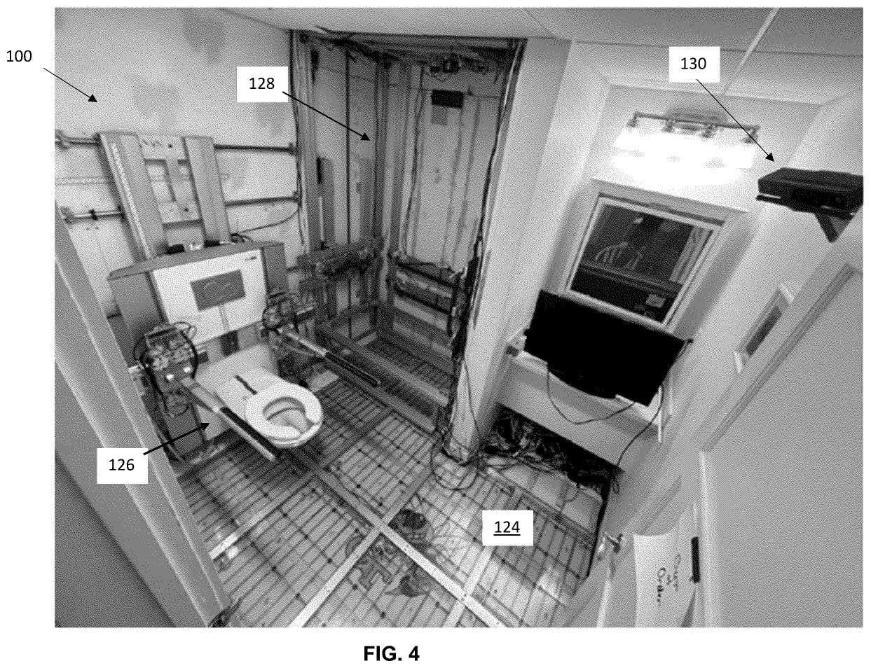

FIG. 4 illustrates an exemplary layout and component of the bathroom environment 100, showing, for example, the smart floor 124, a toilet transfer system 126, and a bathing transfer system 128, and cameras 130. The components can provide data regarding toilet, tub, and shower transfers in the bathroom environment 100, including offering objective measures to, for example, provide OTs and similar professions with improved understanding of transfer performance, inform training of OTs, and to eventually correlate data from embedded sensing systems with transfer performance to automatically measure an individual's changing abilities and intelligently adjust the AT fixtures to meet their needs.

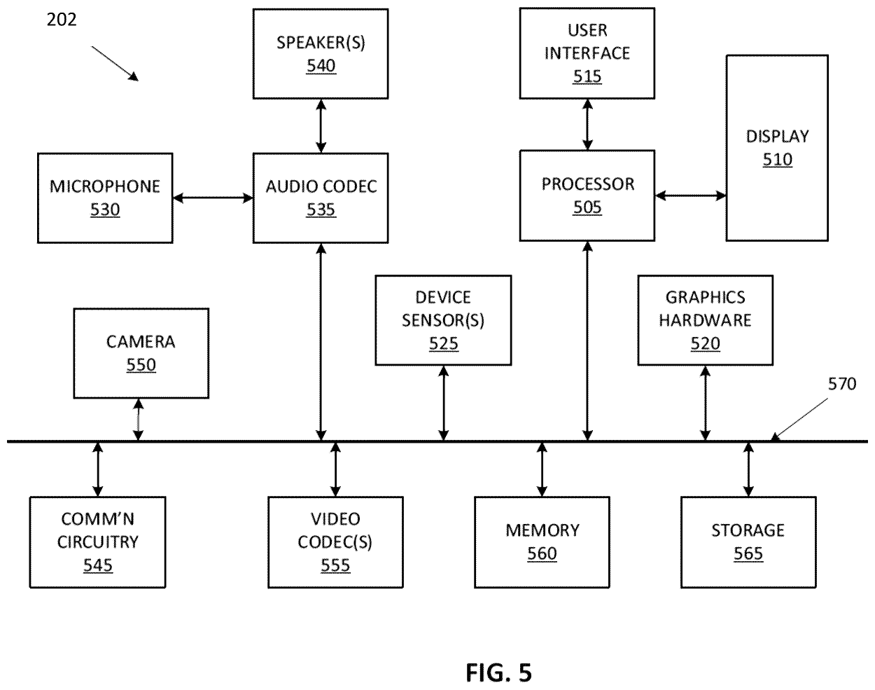

FIG. 5 illustrates an exemplary functional block diagram of illustrative programmable electronic assistive technology computing device 202 according to one embodiment. Computing device 202 may be, for example, a mobile device (e.g., a cell phone), personal media device, portable camera, a tablet PC, laptop, desktop computer system, or the like. As shown, computing device 202 may include processor 505, display 510, user interface 515, graphics hardware 520, device sensor(s) 525 (e.g., proximity sensor/ambient light sensor, gyroscope, pressure etc.), microphone input 530, audio codec(s) 535, speaker(s) 540, communications circuitry 545, camera 550, video codec(s) 555, memory 560, storage 565, and communications bus 570.

Processor 505 may execute instructions necessary to carry out or control the operation of many functions performed by computing device 202. Processor 505 may, for example, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may provide assistive technology data, such as sensor data, user preferences, environmental data (e.g., assistive equipment in use), patient needs, or the like. Processor 505 may be a system-on-chip (SOC) such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as a neural engine processing core.

Memory device 560 may include one or more different types of media used by processor 505 and/or graphics hardware 520 to perform device functions. For example, memory 560 may include memory cache, read-only memory (ROM), and/or random-access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 505, such computer program code may implement one or more of the methods or processes described herein.

The disclosed system and components may be used for the following, for example: 1) classroom/lab/office assessment of individual transfers by occupational therapists (OTs) (e.g., research, training, and practice); 2) OT longitudinal home monitoring of transfer performance to inform adjustment needs; and 3) manual or automated adjustment of bathroom AT fixtures or devices (e.g., community living, home, etc.) based on individual preferences and longitudinal sensing in response to changing needs.

### SmartBathroom Example

The present disclosure may provide a SmartBathroom that is a data collection and automation solution for measuring forces during performance of bathroom transfers by individuals, such as toilet, bathtub and shower transfers.

Bathroom assistive technologies, such as toilet safety frames and grab bars, can help people with long-term mobility disabilities safely accomplish tasks like toileting and bathing. The SmartBathroom may accommodate individuals whose support needs vary over time or even fluctuate over the course of the day, in improving transfers in the bathroom settings, including providing objective measures that are not easily determined through professional (occupational therapist) observation alone. The SmartBathroom may incorporate robotics to provide the ability to automatically adjust the bathroom environment to support the changing needs of individuals.

The SmartBathroom can be a fully instrumented testing environment within an authentic home environment, that is designed to study simulated bathroom toilet and bathing transfer performance objectively and subjectively with visualizations of the real-time transfer as well as for post-trial transfer assessment. The SmartBathroom may comprise core components that can be integrated to assess simulated bathroom transfer, Those components, may include, for example:

SmartFloor Data Capture System 700, including e.g. floor 124—a system for monitoring the location of feet centroids on the floor of the bathroom, including when transferring with the Smart Toilet Transfer Evaluation System and Smart Bathing Transfer Evaluation System.

SmartToilet Transfer Evaluation System, e.g. toilet transfer system 126, —a system for studying simulated toilet transfer performance (e.g. toilet grab bars and seat).

SmartBathing Transfer Evaluation System, e.g. bathing transfer system 128—a system for studying simulated bathtub and shower transfer performance (e.g. bathtub grab bars).

Synchronized Video Ground Truth Recording System—Four video cameras and application to record performance during transfer sessions (consisting of numerous participant transfer trials) with synchronized timecode embedded in video.

Synchronized Video Depth Sensor Ground Truth Recording System—Four Microsoft Kinect sensors and systems to record video, depth, and skeletonization during trials of transfers

Sensor Data Central Capture System—Centralized capture of sensor data with control tools. (Thinger, local VPN)

Long Term Data Archive—Long term storage of sensor data (TRENS server).

Sensor Visualization Tools—Individual tools to visualize each of the capture systems.

These components work together to capture the movements and actions of the participant in the bathroom environment. The resulting dataset can be used to evaluate the participant's transfer performance, i.e. the ability to perform the actions or test the effectiveness of an accessibility product in a controlled environment.

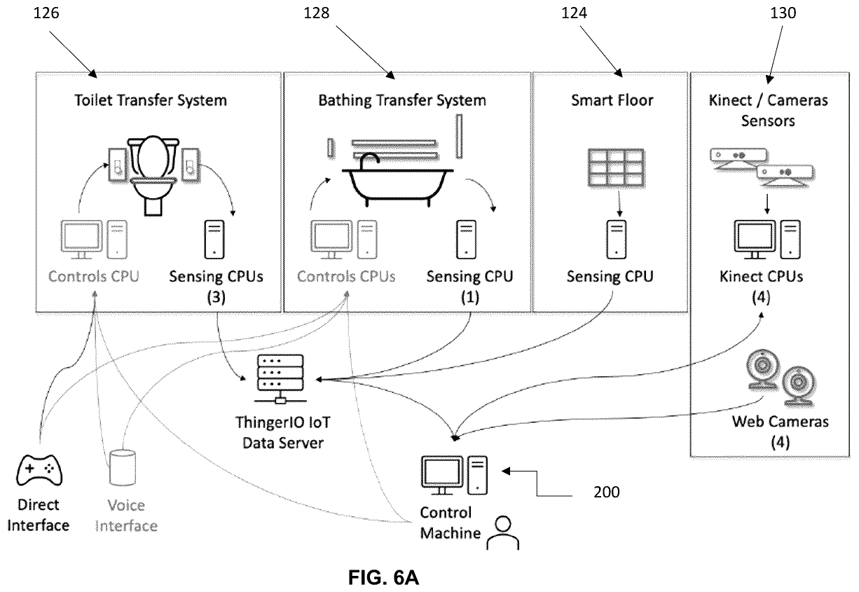

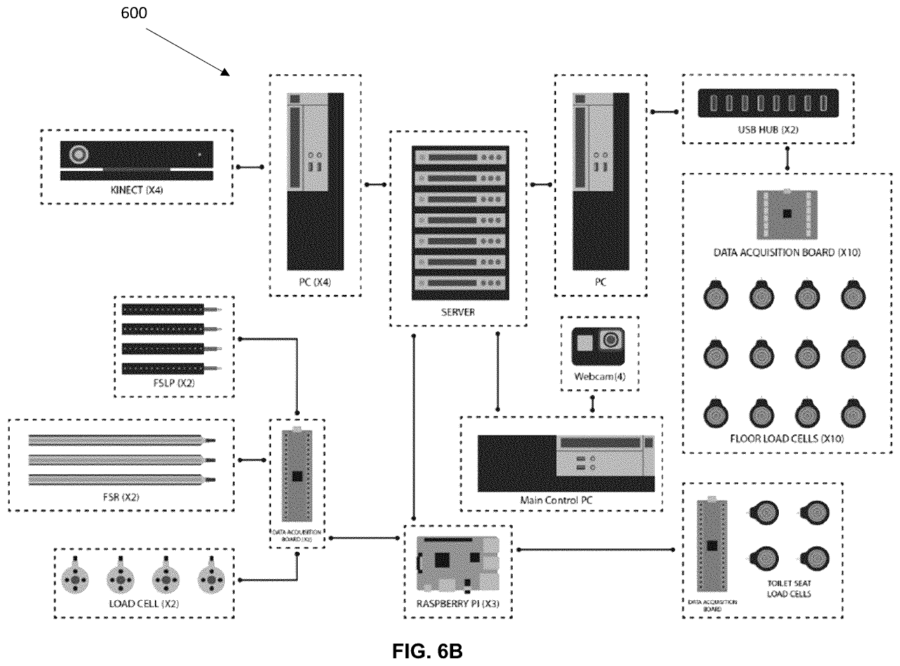

FIG. 6A shows a diagram of exemplary system architecture and data transfer components associated with the bathroom environment 100 in accordance with one or more embodiments such as the SmartBathroom. The components may include, for example, toilet transfer system 126, bathing transfer system 128, smart floor 124, and cameras 130. FIG. 6B shows exemplary components of a transfer performance assessment of the system 600 in accordance with one or more embodiment including, e.g. computing device 202 (FIG. 2), server 212 (FIG. 2), toilet sensors, e.g. load cells sensors floor sensors, e.g. sensor 112 (FIG. 1B), data acquisition boards, FSR sensors, FSLP sensors, kinetic camera, e.g. camera 130 (FIG. 4), and webcam.

The SmartBathroom can be comprised of multiple sensing system components, control system components, camera systems and servers to facilitate data capture and retrieval. Exemplary components of the SmartBathroom are described in detail below.

Referring to FIG. 7, the SmartFloor system 700 can be designed to measure the distribution of forces of a participant's feet and assistive technologies on the floor, e.g. floor 124, of the bathroom environment 100 as they approach, perform a transfer, and depart the bathroom environment 100. Force measurements (e.g. those obtained from the sensors of the bathroom environment 100) may then be used to evaluate how the individual moves during transfers, including gait patterns when approaching the toilet and pivoting to transfer. The SmartFloor may comprise a modular floor with sensing embedded therein, a custom embedded computing device on each panel with configuration of the modular, and software with the configuration of the smart floor.

The construction of the floor can be modular with panels comprising of two layers, e.g. upper layer 702 and lower layer 704, as seen in FIGS. 8A-8D. Layers 702 and 704 can be, e.g. made of polycarbonate (each ⅜″ thick), with load cell sensors in the lower layer and adjustable threaded screws in the upper layer. The lower layers can be CNC routed to provide precise positioning of for example, 12 load cells (e.g. Measurement Specialties FX1901) to be equidistant from each other (e.g. 7⅞″). The floor may comprise a controller board with USB connection, wiring to the load cells, and space for USB cables. The upper layer of the panel may have threaded holes positioned exactly above the centers load cell sensors. Hex set screws can be inserted through the upper layer to the load cells in the lower layer. The hex set screws can be adjustable to level the floor so it “floats” atop the load cells. In an example, pressure mapping can be incorporated into the floor to map the feet and travel thereof by the individual.

A number of panels (e.g. 10 panels) can be used in the Smart Floor system 700 to cover most of the bathroom floor area of the bathroom environment 100 including the approach from the door, under the toilet, up to the sink, and under the tub/shower area. For installation, the lower layer of each panel can be leveled and screwed to the subflooring and the upper layer can then be placed on the lower layer of each panel, ensuring the hex screws are positioned on each load cell center. The panels can be held together by inset aluminum straps, for example, and affixed with screws. The smart floor may have a plurality of load cell sensors (e.g. a total of 119 load cells) that are distributed across the floor. FIG. 8A illustrates an exemplary grid pattern for the upper layer 702 of modular floor panel and FIG. 8B is a schematic for CNC routing of upper layer 702 of the modular floor panel. FIG. 8C show load cell and channels layout for lower layer 704 of modular floor panel and FIG. 8D shows the lower layer schematic for CNC routing of lower layer of modular floor panel. FIG. 8E shows an exemplary layout of the 10 modular panels for the SmartBathroom lab environment 100.

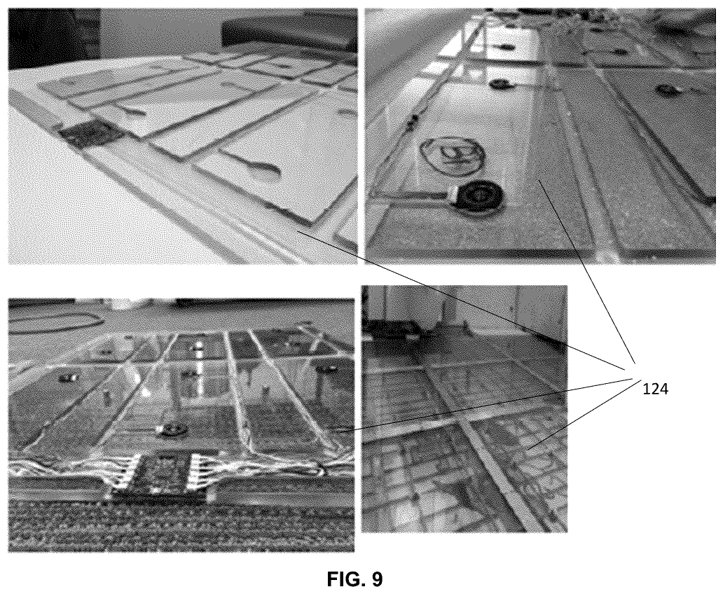

FIG. 9 illustrates an exemplary polycarbonate lower layer of the floor 124 with CNC routed areas for sensors, wires, and electronics boards; an exemplary lower layer of floor 124 with load cells inserted and wires running through the channels; an exemplary lower layer of floor 124 with electronics board and load cells installed, as well as guide pins to align second layer; and a completed floor 124 with the upper layer installed to rest on load cells and aluminum straps installed to hold panels together.

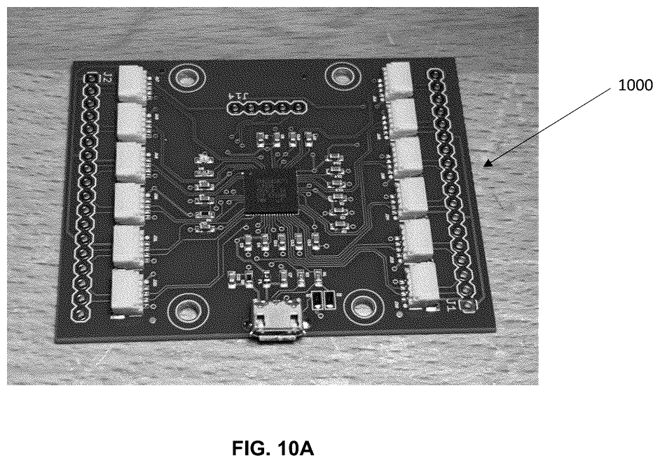

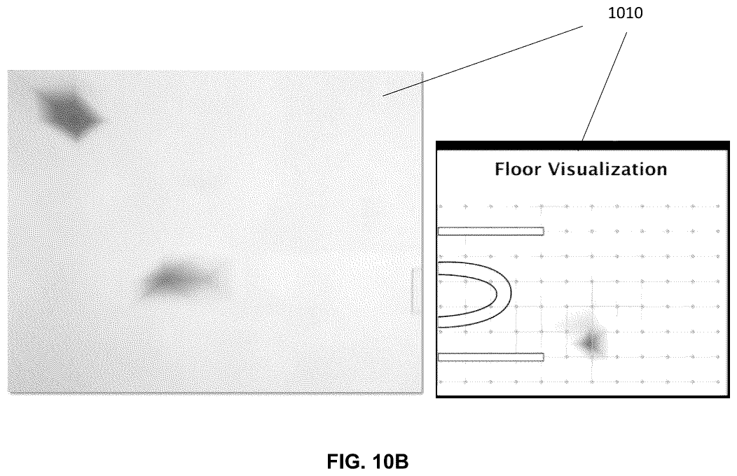

FIG. 10A illustrates an exemplary 12-channel differential ADC board 1000; and FIG. 10B illustrates a visualization 1010 of the smart floor pressure data overlaid on the floor grid. Data capture hardware of the SmartFloor system may comprise a data capture board, e.g. a custom Cypress 5LP PSOC based embedded device. A microcontroller can be used to implement a 12-input differential ADC capture system utilizing the flexible analog fabric to switch the inputs to the ADCs. The device can capture the load cell analog values and streams them to the host PC via the USB subsystem. Each 12-load cell panel, for example, has a single capture board. The data streaming to the server, e.g. server 212, includes the individual load cell values and interspersed with the location of each load cell sent every 10 seconds.

Data capture software on the SmartFloor server computer reads serial data from the 10 modular floor panel devices and sends the data to the ThingerIO server. This data is then read by visualization software to represent the center of pressure forces on the 2-dimensial floor layout, as seen in FIG. 10.

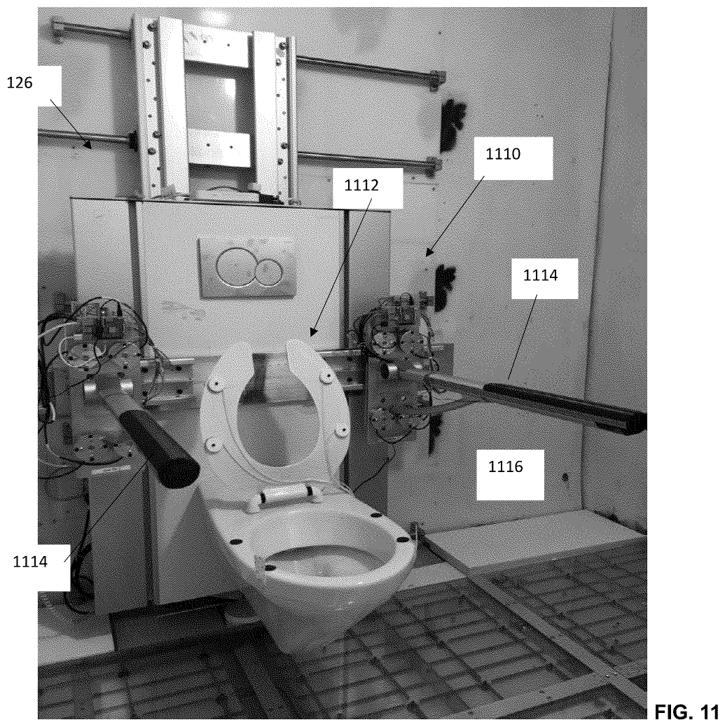

Referring to FIG. 11, the Smart Toilet Transfer System (STTS), such as the toilet transfer system 126, is a collection of sensors and tools in the SmartBathroom environment used for studying the transfer performance of individuals both objectively through sensing and subjectively through in-person observation and review of recorded video. The STTS may comprise of an adjustable toilet 1110, a toilet seat 1112 with integrated pressure sensors, an instrumented set of bilateral grab bars 1114 on either side of the seat 1112, and floor sensors (described above) which may directly at the front of the toilet 1110. These sensors allow the system to measure and ultimately evaluate the safety of the transfer movements.

The adjustable toilet 1110 may be a Pressalit motorized toilet, for example, that is used as the base of the SmartToilet Transfer System. It can be moved vertically using a simple up/down arrow control. The toilet 1110 can be moved horizontally to allow for greater space on either side of the toilet in the tight constraints of the bathroom environment 100. This flexibility in position allows users to adjust the toilet 1110 to their preferences and makes it a little easier for caregivers to aid in transfer.

In an example, the adjustable toilet 1110 can be mounted on an aluminum bracket with wheels mounted to the bottom and then attaching the toilet to five horizontal bars using 10 bearings. A toilet drain can be connected to the sewer line through an accordion drain hose.

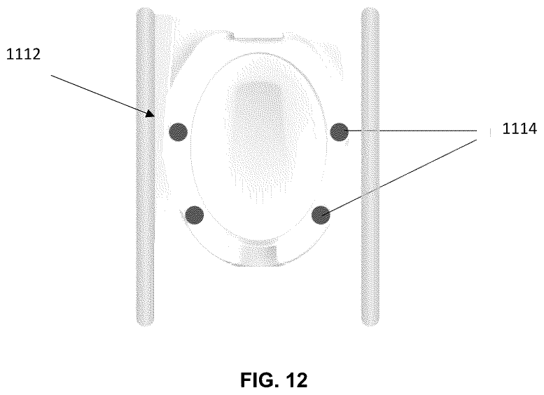

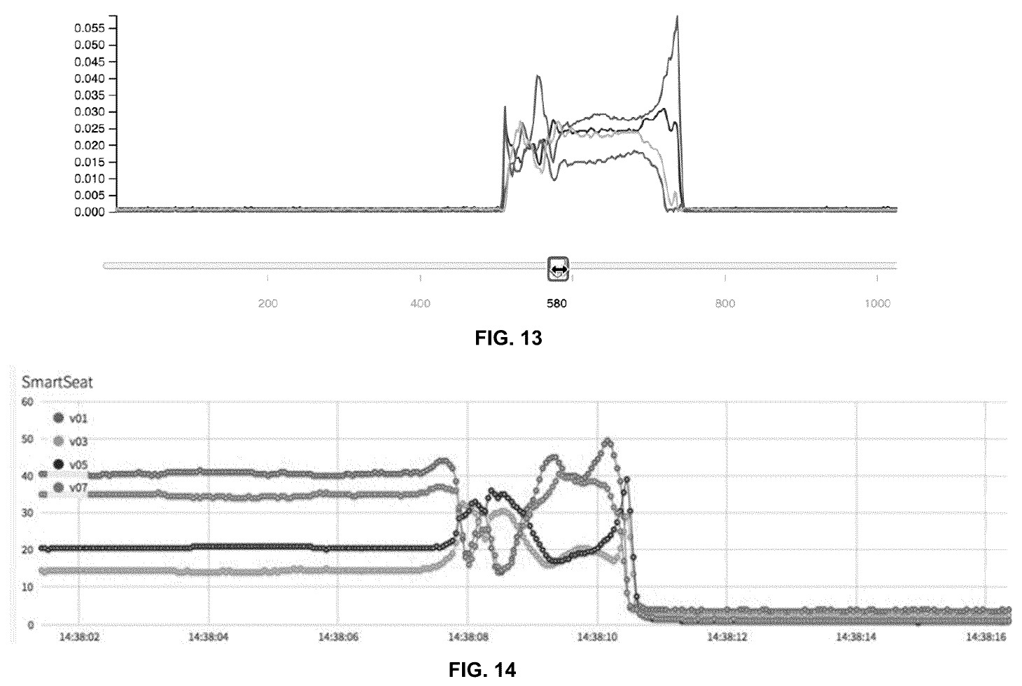

Toilet seat 1112 can be equipped with a number of sensors 1116, e.g. 4 load cells (e.g. Measurement Specialties FX1901), as seen in FIG. 12, that can capture the forces on the seat exerted by an individual during transfer and while in a seated position. These load cells 1116 measure the impact of an individual sitting on the seat, their movement while seated, and motion when preparing to transfer off the seat. In an example, FIG. 13 illustrates full data waveforms of the four loads on the smart seat showing the full transfer forces on the toilet seat 1112 in time, and FIG. 14 illustrates Augmented seat, load cell locations, and data output showing the transferring off the seat 1112.

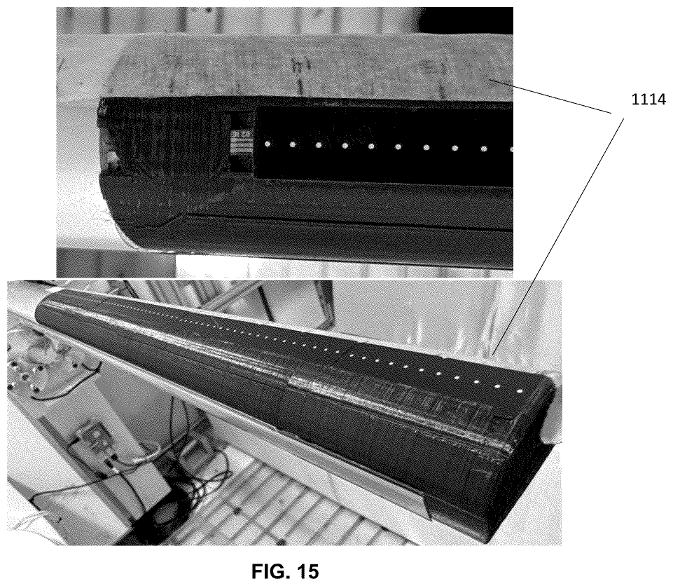

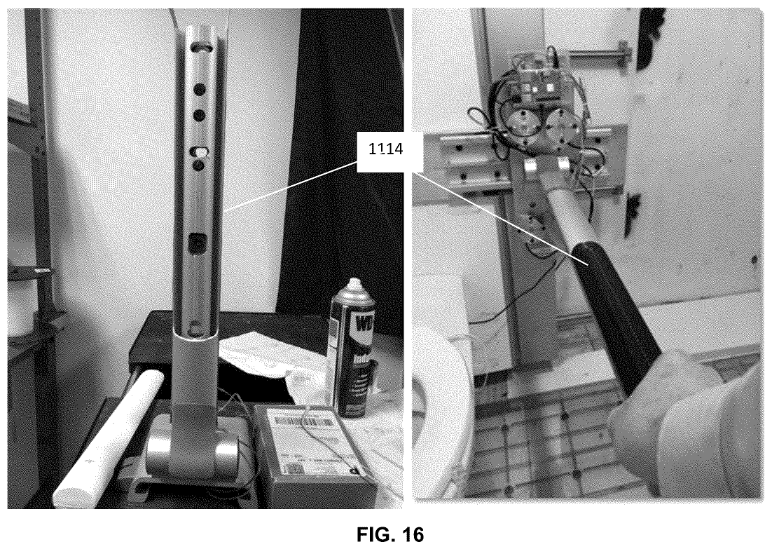

Referring to FIGS. 15 and 16, the grab bars 1114 for the STTS may be, for example, fold down grab bars with integrated counterbalance in a bilateral configuration. The bars 1114 can be designed to be manually adjustable to different horizontal and vertical positions. For the STTS, the grab bars 1114 can include different sensing mechanisms to capture grip position, relative grip strength and net force on the grab bars. Grip position on the grab bar can be captured by a series sensors, e.g. a series of Force Sensitive Linear Potentiometers (InterLink 4″ FSLP), which measure a position along the sensor length as well as the force applied on the sensor. The FSLP sensors can be instrumented by modifying the fold down grab bar 1114 with integrated counter-balance bar by removing the rubberized insert and replacing it with a custom-designed, 3D printed insert that provided a more ideal surface for the sensors and allowed sensor wiring to tunnel through the bar, as seen in the close-up view of FIG. 15. The main aluminum bar can have drilling holes for the wires to thread through the bar rather than along the grip surface.

The relative grip strength can be captured by the force value generated by the FSLPs on the top of the grab bar and Force Sensitive Resistors (InterLink 24″ FSRs) along the other sides as shown in the image. FSLPs (Force Sensitive Linear Potentiometers) and FSRs (Force Sensitive Resistors) detect force or pressure applied to them. The FSLPs and FSRs are interfaced with a microcontroller board (e.g. an Arduino Mega) which reads the data from the sensors then transmits the data to a computing device, e.g. Raspberry Pi, to send the data to the server, where the data can be stored, processed, and/or analyzed.

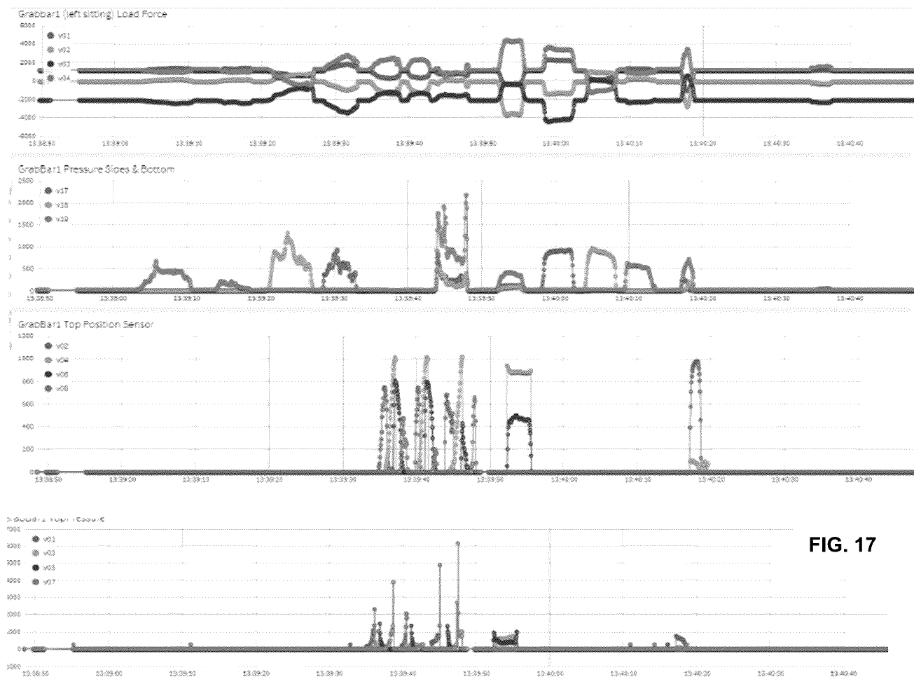

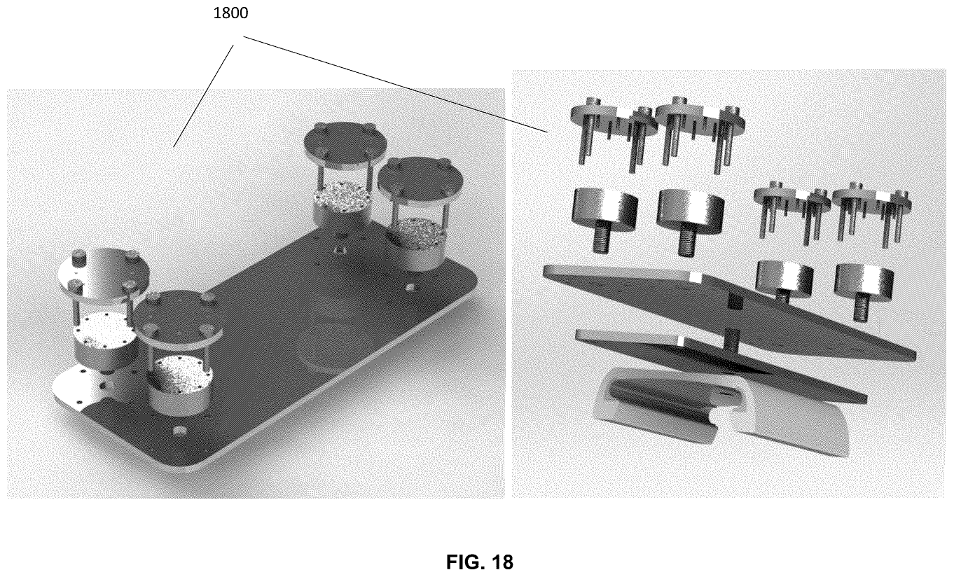

The grab bars 1114 can include drilling to allow sensor wiring to tunnel under adjacent sensors. The 3D printed insert provides a flat surface, a seen in FIG. 16, for the sensors to improve the sensor reliability. FIG. 17 illustrates exemplary time plots of the grab bar sensors showing (1) load cells, (2) side and bottom FSRs, (3) FSLP top position, and (4) top pressure sensors, respectively.

In an example, in order to measure net force exerted on the grab bars 1114 and the direction of that force, the grab bar was removed from the sliding mount. A new mount was designed to fit between the bar and the slide mount of the system. The mount can be comprised of 4× Omega 1c204-1K load cells to capture the net force exerted by the person on the bar. The torque generated by the grab bar can be translated to force on the load cells by the mechanical structure, including an allen bolt in the center to produce a joystick type operation. The load cells can be interfaced to a PSOC board which then outputs the data to the Raspberry Pi to send to the server.

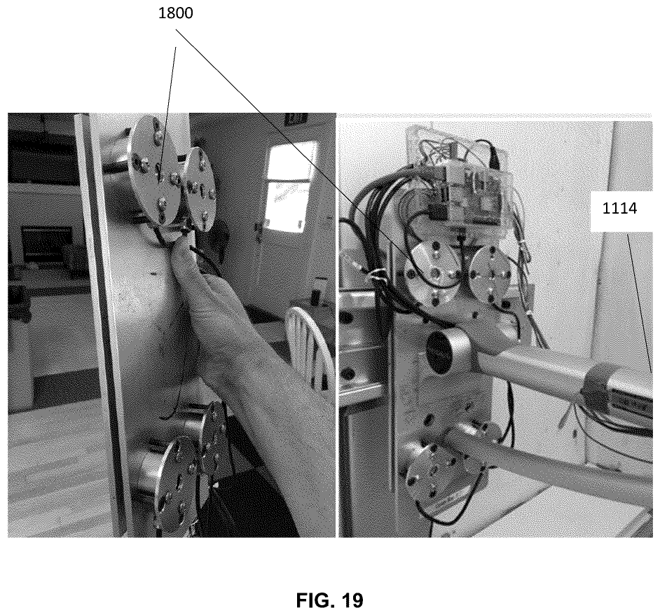

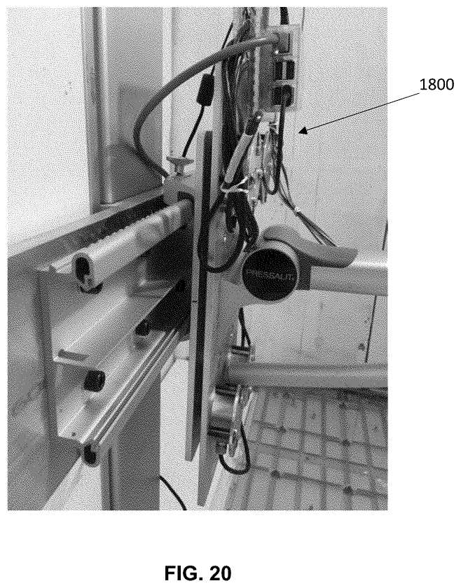

FIG. 18 illustrates an exemplary custom mount design 1800 to isolate movement of the grab bar 1114 from the frame of the toilet 1110, thus allowing accurate force measures. FIG. 19 illustrates the mount 1800 without the grab bar attached, showing the load cell configuration alongside the mount with grab bar attached and sensing components. FIG. 20 is a side view of the mount 1800, and a mechanism for manually modifying the horizonal position is shown.

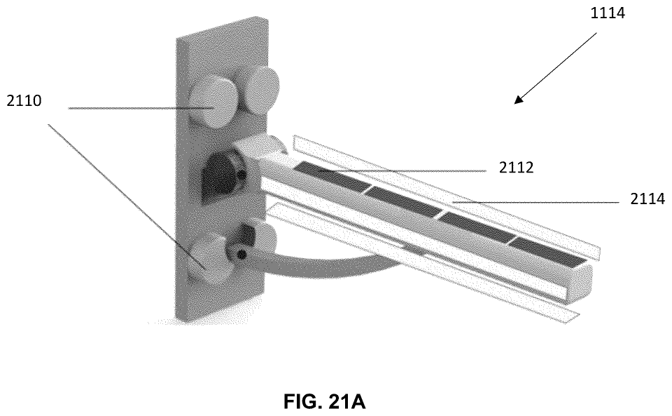

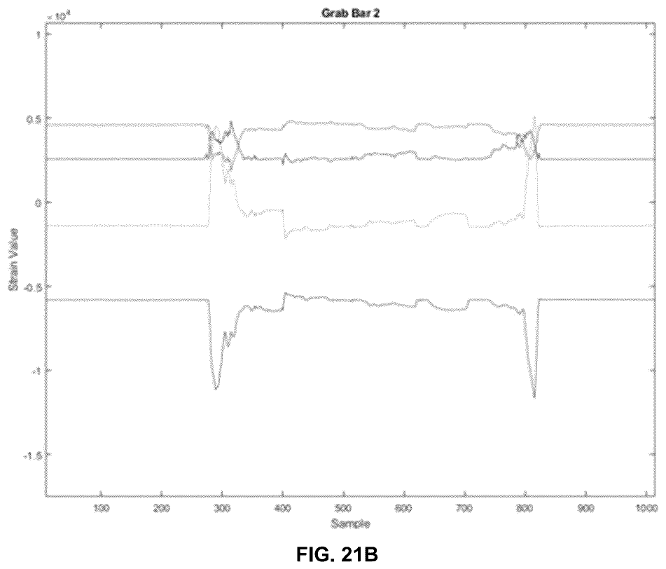

FIG. 21A illustrates grab bar 1114 with sensors arranged on the grab bar 1114. The sensors may comprise load cell sensors 2110, FSLP sensors 2112, and FSR sensors 2114. FIG. 21B illustrates an exemplary time series plot of the mount load cell forces showing raw waveforms from the load cells when the grab bar 1114 is used.

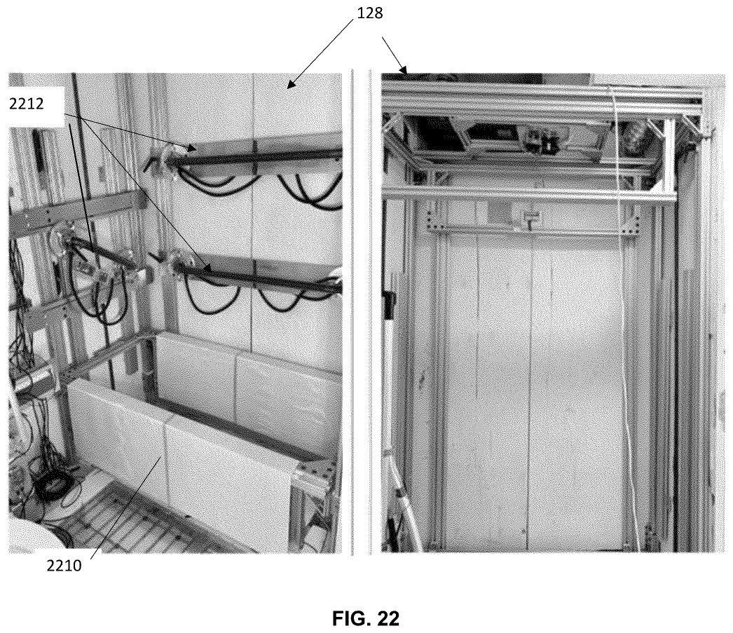

Referring to FIG. 22, the Smart Bathing Transfer Evaluation System, such as the bathing transfer system 128, is a system for studying simulated bathtub and shower transfer performance. The system may comprise of a bathtub 2210 capable of moving to the ceiling to allow for both bathtub transfers and shower transfers. Bathing grab bars 2212 can be flexible, allowing repositioning to fit the preferences of the user and are instrumented with sensors to detect grip and position as well as force exerted on the bars. The smart bathing transfer system can include a tub cradle that holds a 52″ bathtub, for example, and grab bars that are either vertically adjustable (long-side) or have flexible adjustment (short-ends). 2. The tub cradle can be lifted to the ceiling with the motor and drive system.

The tub lift system can be designed to allow bathtub 2210 to fit into a cradle that can lift from floor to ceiling, allowing for conversion from bathtub to a walk-in or roll-in curb-less shower. This system also allows the tub 2210 to be set to different heights for evaluating the changing needs as tub height changes. In an example, the tub and lift system can use four 8020 t-slotted aluminum frame with vertical supports at each corner of the tub/shower space, with horizontal supports at all four top edges and on the three bottom edges along the wall. There is no horizontal support at floor opening to the bathroom to allow for a “curb-less” entry.

The cradle for the bathtub 2210 can be built out of 8020 t-slotted aluminum supports. Double T-Slotted slides and wheels can be used to keep the tub cradle secure within the framing. At the top, a modified garage door opener motor can be mounted to the frame and a pulley and belt system used to drive two threaded rods positioned on the head and foot ends of the tub. These rods can extend through the tub cradle on the top edges, where a nut can be embedded, which effectively moves the tub up and down as the rods turn. A dual direction switch can be wired to the motor which is used to control the motor direction and position the tub. In order to move the tub to the ceiling for shower transfers, the grab bars 2212 can be removed and reattached.

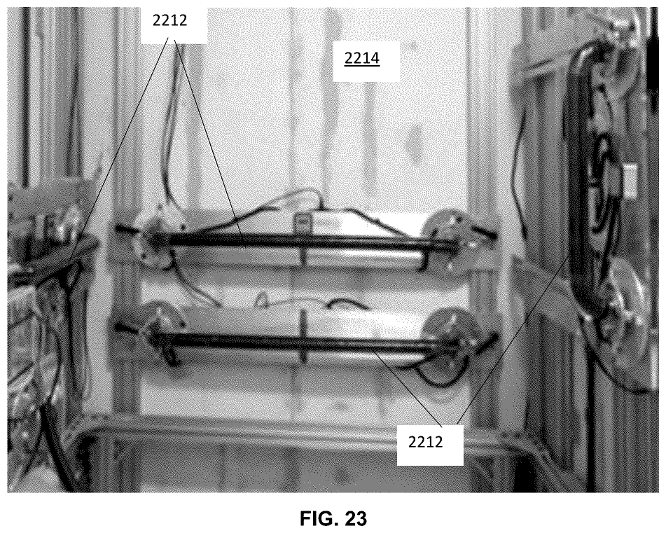

Referring to FIG. 23, the bathtub grab bars 2212 can be designed to allow for a flexible configuration, while also allowing for measurement of the forces exerted on the grab bars by users and sensing the type of grip used when transferring into and out of the tub. In an example, two lengths of bars can be used, 36″ for the tub sides and 18″ for the tub ends.

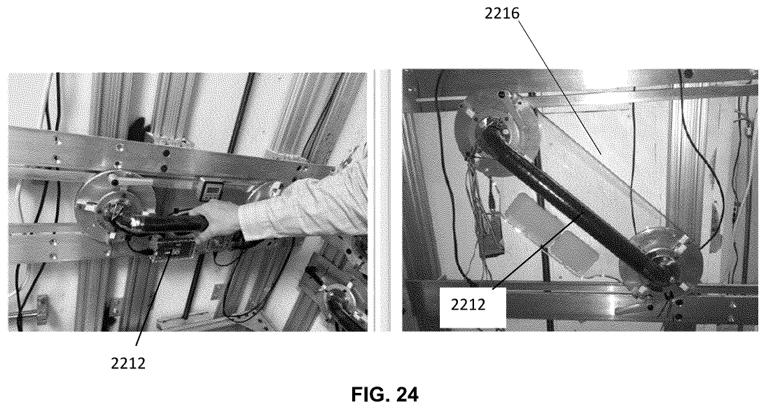

FIG. 24 illustrate exemplary adjustment mechanisms for the grab bars 2212. In an example, the two bars that extend along the long wall 2214 (FIG. 23) of the tub 2210 and can be adjusted vertically. The bars 2212 may be adjusted vertically using two t-slot clamps inserted into dedicated vertical bars. These bars 2212 can thus be easily removed as well. The two grab bars that are on either end 2216 of the tub 2210 are configured to be more flexible and adjust vertically and horizontally and can pivot to any angle. These bars can be configured as a unit of multiple mechanically moveable parts that provide flexible adjustment. Each unit can be mounted using four slides, onto two vertical, aluminum supports that are attached to the wall. This design allows vertical motion of the grab bars. The vertical adjustment requires release of quick release clamps that pinch the slides together around the supports. The next components in the unit are two horizontal aluminum supports with a slot running the length into which the main grab bar component ends are clamped, one to the top support and one to the bottom support. When the horizontal supports are separated, the main grab bar pivots and then can be adjusted horizontally.

In order to adjust the pivot of the bar, the two clamps at each end of the main grab bar can be released, followed by release of the quick release clamps on either the top or bottom horizontal support. This allows for free movement of the main grab bar to the preferred angle. Once set, the main grab bar end clamps are clamped to allow the bar to serve as a handle, then the remaining clamps on the vertical support can be released to allow vertical adjustments. This design allows for rapid readjustment of the grab bar positions to account for user preferences.

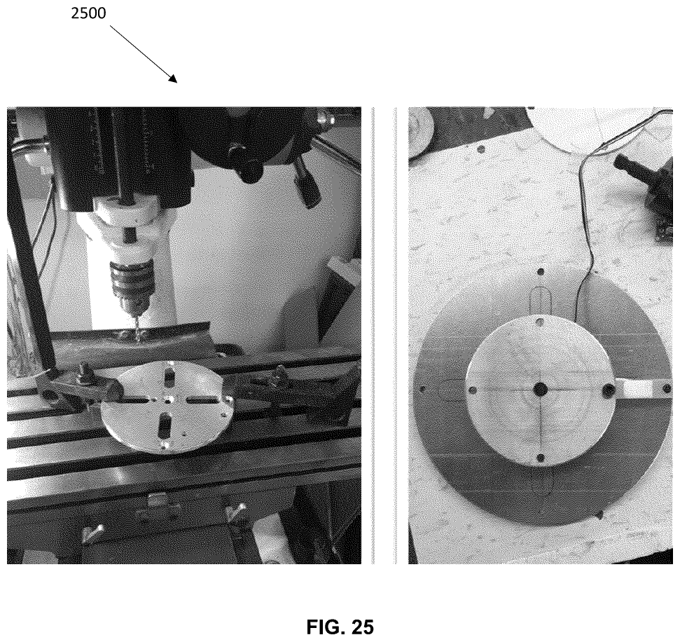

FIG. 25 shows an exemplary garb bar sensing system 2500. FIG. 25 illustrates two discs separated by loads cells, e.g. four bar-type load cells (e.g. 20 kg). Each end of the main grab bar can have the two discs separated by the bar-type load cells. The main grab bar can be a 1¼ inch diameter grab bar that has been instrumented with sensors. Each bar can be affixed to two custom-designed mounts at each end of the bar. The mounts can be, for example, constructed of two layers of aluminum discs instrumented with four bar type load cells (e.g. Phidgets 20 kg micro load cell) positioned between the discs to capture the force applied on the bars. These load cells can be attached to the same custom electronic board used for the SmartFloor (a custom Cypress 5LP PSOC based embedded device). The device captures the load cell analog values and streams them to the host PC via the USB subsystem.

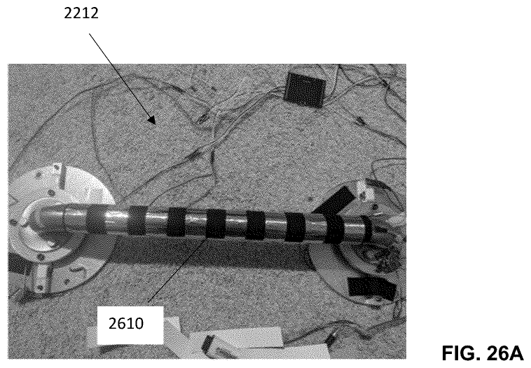

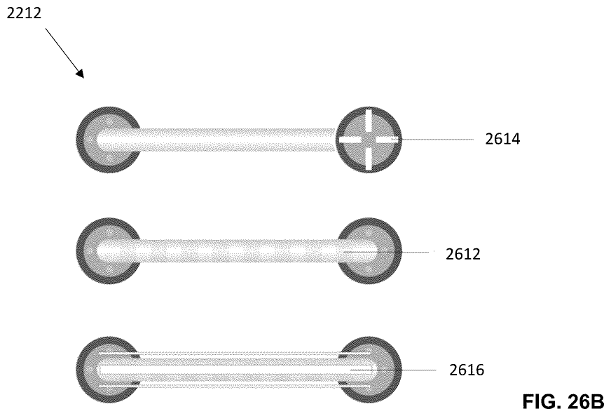

FIG. 26A illustrates an exemplary grab bar 2212 which may have, for example, a copper film 2610 attached to capacitive sensors to detect grip location on the bar. FIG. 26B illustrates diagrams of the grab bar 2212 used with different exemplary sensors, e.g. load cell 2614, capacitive touch pads 2612, or FSRs 2616, for detecting grip and forces on the bars. To detect how one grips the bar, the load cells 2614 can be located at the ends of the grab bar, the capacitive sensing copper strips can be spaced along the bar, and the FSRs can be positioned on each quadrant of the bar.

Capacitive sensors and force sensing resistors (FSRs) are used to detect grip position and relative grip strength. The grip sensing can use layers of grip tape with sensors isolated between the warps of the grip tape. The first layer can comprise of a tape on the steel bar to isolate enamel coated wire from the metal. Wires can be run from a capacitive control board (e.g. Adafruit MPR121) to the locations of the copper foil wraps spaced evenly along the bar. The next layer can be a wrap of grip tape allowing the copper wire to fit through the tape where the copper will be positioned. FSRs can be positioned on the quadrants along the bar (top, front, bottom, back) with wires running to a prototyping shield for the Arduino controller.

Another layer of grip tape can be wrapped around the FSRs then the copper wraps can be added over the top with the enamel wires running through the wraps and soldered to the copper foil. A final layer of grip tape protects the copper wraps and can be wrapped around the curves in the grab bar to secure all wires close to the mounts. A plastic heat shrink wrap can be added to the design to allow for sanitizing the bar easily after use. All wiring for the grip sensing can be soldered to a prototyping shield and attached to the microcontroller board (e.g. Arduino Mega) which reads the sensors and sends the data through the serial USB connection to the main tub grab bar PC, which in turn reprocesses the data and forwards to the Thinger IoT Cloud server.

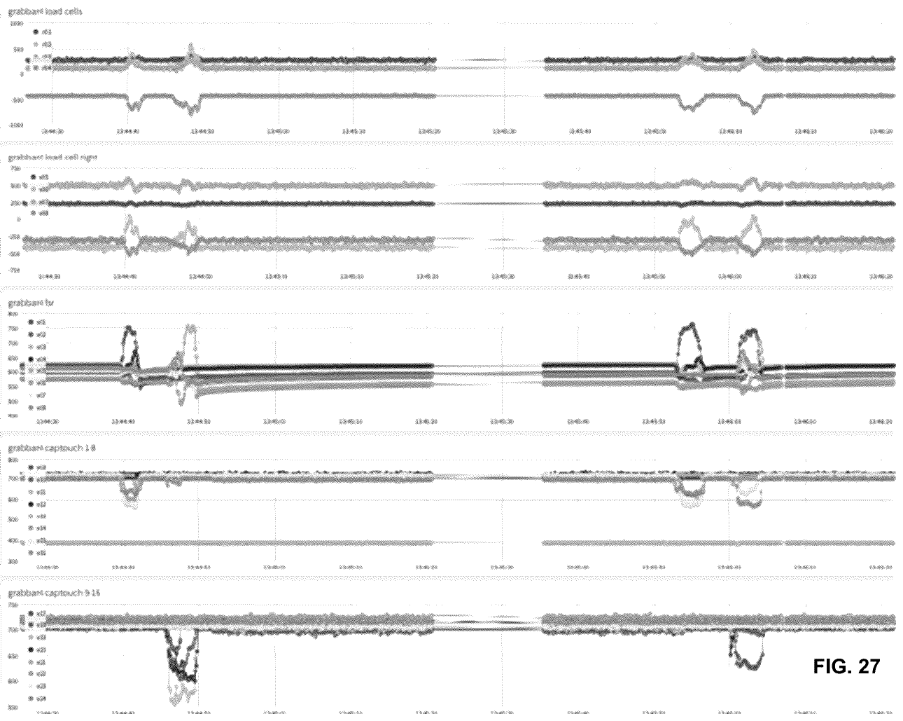

FIG. 27 illustrates time plots of exemplary outputs of one of the 36-inch instrumented tub bars from raw sensor data. FIG. 27 shows an example of 36-inch tub grab bar sensing outputs, including ThingerIO Dashboard time-based plots (x-axis) of interaction with the bar in order from top to bottom: (1) force of four load cells on left (2) force of load cells on right of bar, (3) force on eight force sensing resistors positioned on quadrants along length of bar with four on left half and four on right half of bar, (4) combined proximity and force on eight capacitive touch sensors on the left half of the bar and (5) on eight capacitive touch sensors on the right half of bar.

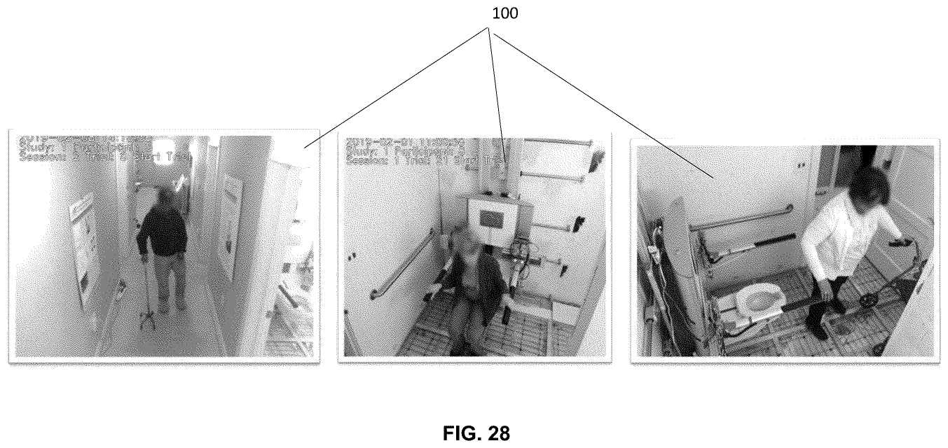

FIG. 28 are images of an individual/participate in the bathroom environment 100 including: (left) the camera provides a view of the participant approach down the hall; (middle) a view from the sink; (right) a view from the tub and one not pictured from the wall above the toilet provide multiple angles for reviewing a session.

The SmartBathroom can have a number of web cameras that observe the approach down the hall to the bathroom environment 100 and different angles of transfer activity within the bathroom. Cameras can be positioned using a remote pan, tilt, zoom mount to change the view to focus on toilet or tub areas. The cameras can be recorded through one or more custom software applications running on a local PC. The recording can start when the operator starts a session and ends when they stop a session. A session is defined as a series of trials performed during a participant visit. At the end of the session, the software can recode the raw images, such as by using ffmpeg to compress and export an mp4 file with text showing timecode, participant, session, and trial overlaid onto the frames for each view, resulting a full recording of the “session” of trials with a participant. These videos can later be reviewed by researchers to further analyze transfer.

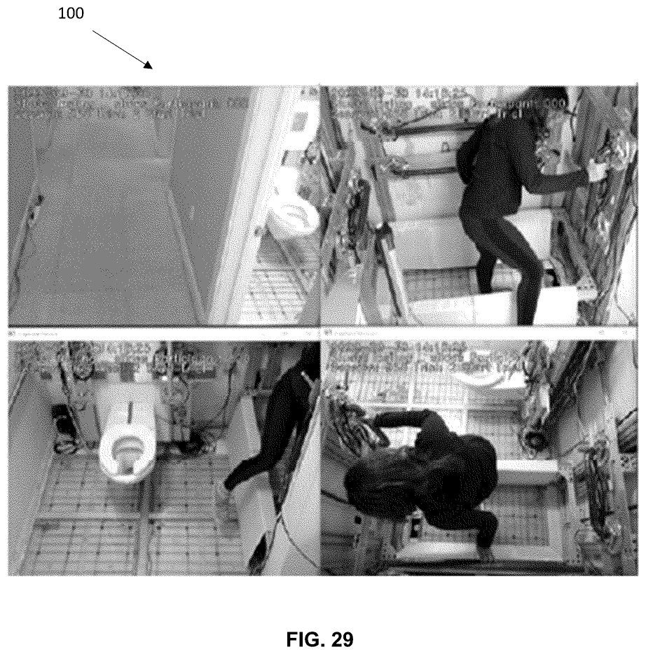

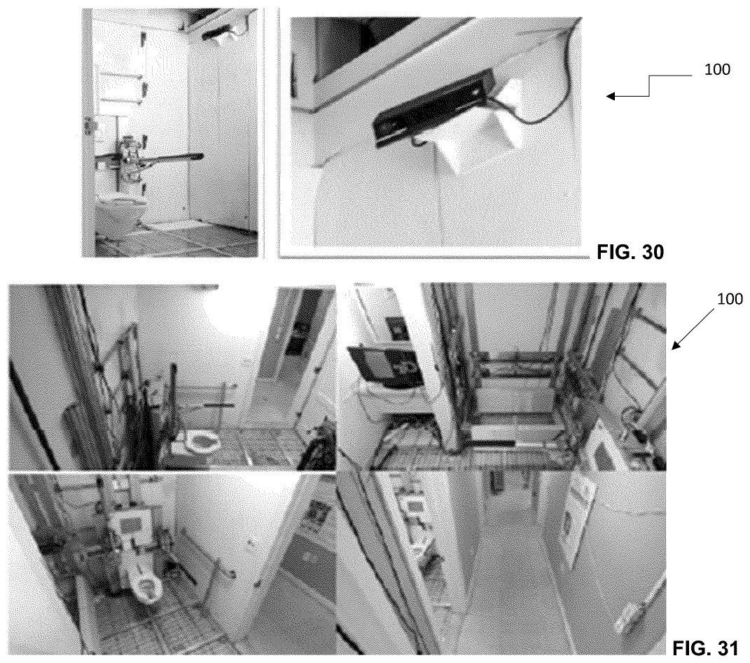

FIG. 29 illustrates four exemplary views of the web cameras as positioned in the SmartBathroom 100 for a bathing transfer analysis. Hall approach (top-left), front of tub (top-right), front of toilet (bottom-left), overhead tub (bottom-right). Microsoft Kinect for windows sensors can be installed in the SmartBathroom, as seen in FIG. 30 to provide high-detailed images and video of the transfer performance in the bathroom environment. In some instances, a custom mount was designed. In addition to web cameras, which provide a quick method for reviewing the whole session, Kinect sensors can be installed to provide more detailed visual images, depth images, and skeletal tracking of the hall approach to the bathroom and the bathroom transfer environments. FIG. 31 illustrates exemplary Kinect views of the bathroom environment 100: side of toilet (top-left), front of tub (top-right), front of toilet (bottom-left), and hallway approach (bottom-right). Microsoft Kinect depth cameras can be installed to provide a view from the front of the toilet, of the side view of the toilet, and of the front view of the bathing area. Each Kinect can have a separate PC to capture and store the raw images.

A custom application on each PC can be configured to restrict recording of the raw images, depth images, and skeletal information for each Kinect to only the period for each trial. This data can be stored locally due to the large data sizes of each high-resolution image stored at around 20-30 Hz. Instead, the application writes a name for each image with a timestamp to the Thinger IO Server for easier syncing with the data in post-session analysis.

The SmartBathroom components can be automated to allow automatic adjustment of the AT fixtures. As abilities change during the course of the day or over time, the system could then adjust to match the needs of the individual(s) using the system. In an example, a design for automation can utilize linear actuators (toilet Grab bars automation uses 4× Glideforce LACT8P-12V-20 and toilet horizontal automation uses 1× Glideforce LACT8-1000BPL) and control boards (Jrk G2 24v13 controller) connected to a Raspberry PI. The toilet position is controlled vertically by the existing actuators in the Pressalit toilet and horizontally by a 12″ linear actuator attached between the toilet structure and the wall, allowing the toilet to adjust for use of the ADA-style grab bars installed on the wall, the bilateral grab bars allowing additional space for a caregiver to assist with transfer from either side of the toilet. The grab bars move with the toilet but can be adjusted independently using two 8″ linear actuators on each grab bar (four total), one vertical and one horizontal, connected between the toilet structure and the grab bar mounts.

The SmartBathroom systems may include software for operation and archiving, including capturing the data from each set of sensors systems and video systems described above, repackaging the data with timestamps when the data was received by the local system, and forwarding that data to an Internet of Things data storage server system, called ThingerIO. The flow of this data can be managed by an Event Control Application. These systems continuously collect data but only write data to the server when a study session is in process. Following data collection, a series of applications are used to export, process, and archive the data.

The server can be a ThingerIO server that is a commercial application capable of receiving, storing, and visualizing time-series data, like the data from the SmartBathroom systems. A separate “Bucket” can be used for storing the raw data and timestamps from each sensor or set of sensors on a SmartBathroom component. “Dashboards” can be created in ThingerIO to visualize the data, providing a quick way to verify that the data appears correct through raw data plotting on time-series plots (FIG. 27).

The Event Control Application can be the control center for the SmartBathroom studies. This software can provide fields for tracking operator name, the study phase, the participant ID, the session (visit) number of the participant, and the trial number within the session. The software has session start and stop buttons and trial start and stop buttons to control the logging of data by trial and session. It also provides a visual status of the capture hardware.

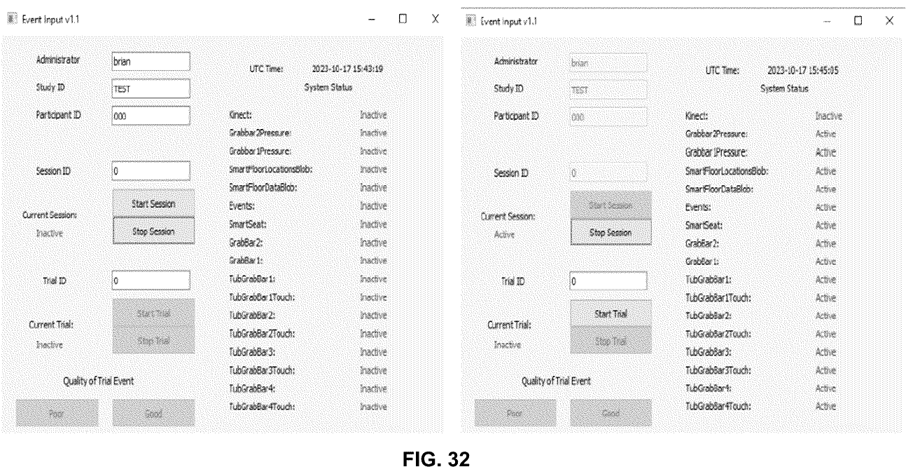

FIG. 32 illustrates an exemplary interface for the event control application for controlling and monitoring sensor streams. As the Session Start button is pressed, the web camera software starts recording for the session. As the Start Trial button is pressed, it sets an access token on the ThingerIO server to allow data to flow into the buckets from all capture software on the multiple computing devices (SmartFloor PC, toilet seat CPU, toilet grab bar left CPU, toilet grab bar right CPU, tub grab bars PC, and four Kinect PCs). As data appears in the ThingerIO “buckets” of data, the software determines the systems are operating correctly and changes status to “Active” on the application's user interface (UI). The Stop Trial button restricts data flow to the ThingerIO server, and the software updates each system's status to “Inactive” as that data no longer updates in the ThingerIO buckets.

Data management applications can be used to collect data from the SmartBathroom systems. For example, an application called DataSlicer has been created to allow researchers to review the list of recorded study sessions of the SmartBathroom by the information entered in the Event Control Application, select, and download the session data. The result is downloaded to a session folder with folders for each trial containing the JSON export of each component from the ThingerIO server.

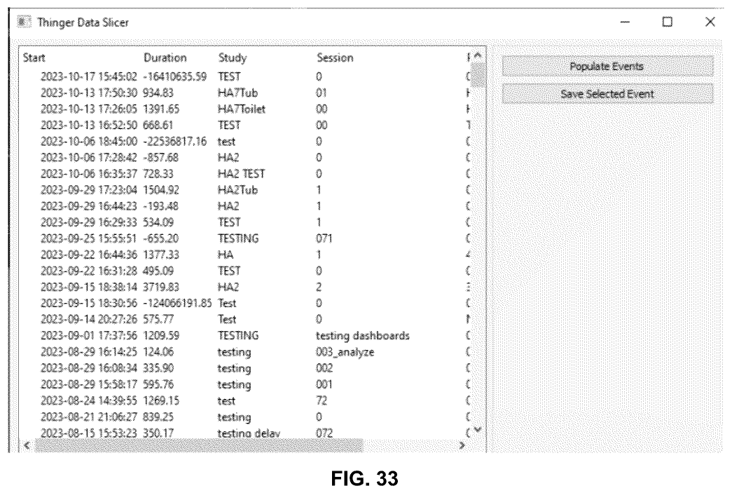

FIG. 33 illustrates a data export tool. For data resampling. Once data is downloaded from the ThingerIO server, a MatLab script can process the files by reading in the JSON files, merging the data from the different components, and interpolating the data to resample it to 20 Hz. The process exports comma-separated value (CSV) files for each trial that contain the resampled data for all components.

Similar to the ThingerDataSlicer, a KinectDataSlicer application has been created to process the Kinect videos from four Kinect systems. The software builds an index of the image names stored on the ThingerIO server, then connects to the mapped network drives of the Kinect systems to find and copy the images found with those names. It stores the copied files by session and trial number. The software builds a list of the image names that were found and provides these names to the ffmpeg (Fast Forward Moving Picture Experts Group) software, which builds a variable frame rate MPEG 4 file. Ffmpeg is then run again to resample this file as a fixed framerate MP4 file. The software finds images, lists their names, and uses ffmpeg to create a video with varying frame rates. Then, ffmpeg converts this video to a standard MP4 file with a consistent frame rate.

This is repeated by the software until all Kinect image output for each system and each trial have been created. All videos are stored under the respective trial folder, completing the collection of data from the session.

In order to monitor the SmartBathroom operation during trials, real-time capture visualization tools can be used to show the current interactions of the user with the sensing components of the toilet transfer system 126, bathing transfer system 128, and smart floor 124. Processing software can be used to generate shapes that approximate the system sensors, which are then false-colored to depict the amount of force or location of the force on the components. This visualization tools can provide real-time monitoring of the systems during transfer studies.

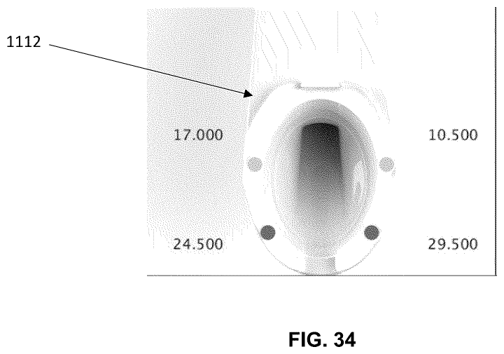

For example, SmartFloor Visualization software can be used to pull the last values for each load cell from the ThingerIO server, then interprets the force data from all load cells to create a heat-map visualization showing the amount of force on each load in 2-dimensional space. SmartSeat Visualization software can be used to pull the last values from the ThingerIO server for each of the four load cells of the seat 1112, then converts the data to the calibrated force on each load cell and displays each result over the 2-dimensional top-view of the toilet seat, both in text and color-mapped on a circle shape. FIG. 34 illustrates visualization of the SmartSeat 1112 showing greater pressure through deeper red color of the circle. Exemplary values are shown beside each sensor circle.

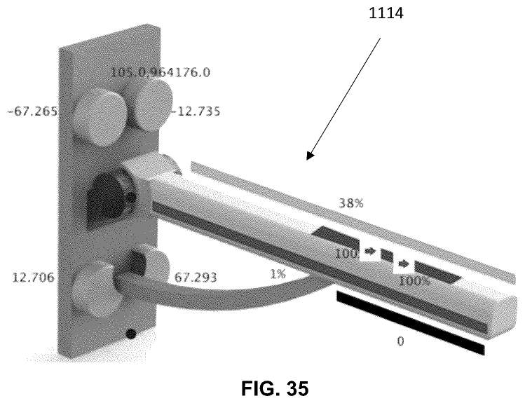

SmartToilet Grab bars Visualization software can pull the last values from the ThingerIO server for each of the sensors on the related grab bar. For the four load cells in the mount, it converts the data to the calibrated force and shows a dot representing the centroid of pressure on the load cells. For the grip FSR sensors, a rectangle runs the length and is placed in proximity to the actual sensor, then the color of the rectangle is mapped to the pressure sensed. The top FSLP force and position sensors are represented by individual rectangles. Each can sense position, so an arrow is overlaid to represent the touch centroid on each. The pressure of each FSLP is a color that is mapped on to the rectangle shape similar to the FSR sensors. FIG. 35 illustrates an exemplary toilet grab bar (e.g. grab bar 1114) visualization showing exemplary values of load cells near the mount. The black dot at bottom of the mount is the offset from center of the centroid of force. False coloring on the long rectangles is the force on the FSR and top rectangle.

Similar to the SmartToilet Grab bar visualization, the Tub Grab Bar Visualizations can include shapes to represent the location of the capacitive touch sensors positioned along the bars and rectangles representing the force-sensing resistors along the bars, but offset when hidden behind the bars. The load cells on each mount are represented by a circle that is centered based on the default values of the load cells.

The SmartBathroom systems described above all work together to measure aspects of performance during bathroom transfers. The software begins the flow of measurements to the cloud storage system. The video systems record the performance. The SmartFloor measures the forces on the floor as the individual enters the bathroom and approaches the toilet; the grab bar force sensors measure the amount of weight exerted on the bars during transfer along with where the user grips and how they grip; the toilet seat measures the impact and movement as the user transfers from standing to sitting, changes while sitting, and the forces of the user during sit to stand transfers. The bathing system grab bars measure the forces exerted on each grab bar as the user enters the bathtub or shower, as they sit in the tub, and as they stand and exit the tub.

These measurements or aspects may then be processed to identify difference in individuals' transfer performance or even how an individual's transfer changes from morning to night or over the long-term. The system may be used to support practitioners in determining changes in the user's transfer techniques or modifications of a user's bathroom fixtures to improve performance, or eventually inform algorithms that automatically reconfigure the fixtures to adjust to the changing needs of older adults and particularly those aging with disability.

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data to facilitate making predictions for subsequent data. Models may be created based upon example inputs to make valid and reliable predictions for novel inputs.

According to certain embodiments, machine learning programs may be trained by inputting sample data sets or certain data into the programs, such as images, object statistics and information, historical estimates, and/or image/video/audio classification data. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

As used in this specification and the appended claims, the singular forms “a”, “an” and “the” include plural referents, unless the context clearly dictates otherwise. Similarly, the adjective “another,” when used to introduce an element, is intended to mean one or more elements. The terms “comprising,” “including,” “having” and similar terms are intended to be inclusive such that there may be additional elements other than the listed elements.

Additionally, where a method described above or a method claim below does not explicitly require an order to be followed by its steps or an order is otherwise not required based on the description or claim language, it is not intended that any particular order be inferred. Likewise, where a method claim below does not explicitly recite a step mentioned in the description above, it should not be assumed that the step is required by the claim.

It is noted that the description and claims may use geometric or relational terms, such as, right, left, above, below, upper, lower, top, bottom, linear, arcuate, elongated, parallel, perpendicular, etc. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

What is claimed is:

1. An assessment system for assessing transfer performance within a bathroom environment, comprising:
at least one assistive device located in the bathroom environment, the at least one assistive device being configured to assist an individual with toilet or bathing transfer in the bathroom environment, and the at least one assistive device being configured to be adjustable within the bathroom environment;
one or more sensors associated with the at least one assistive device, the one or more sensors being configured to measure and collect sensor data during stages of toilet or bathing transfer by the individual using the at least one assistive device within the bathroom environment, wherein the sensor data represents one or more aspects of transfer performance of the individual; and
a control module comprising an assistive technology computing device communicatively coupled with the one or more sensors, the control module being programmed with computer readable instructions that, when executed, cause the control module to:
receive the sensor data from the one or more sensors, and
assess a transfer performance of the individual based on the sensor data.

2. The assessment system of claim 1, wherein the computer readable instructions, when executed, further cause the control module to determine a recommended adjustment in connection with the at least one assistive device and the bathroom environment based on the transfer performance of the individual assessed by the control module, the recommended adjustment being one or both of:
(a) adjusting a position of the at least one assistive device by moving the at least one assistive device from a first position in the bathroom environment to a second position in the bathroom environment, or
(b) adding another assistive device to the bathroom environment.

3. The assessment system of claim 2, further comprising one or more of a toilet transfer system, a bathing transfer system, and a floor transfer system under the toilet and bathing transfer systems, each of the toilet transfer system, the bathing transfer system, and the floor transfer system comprising a sensor of the one or more sensors.

4. The assessment system of claim 1, wherein the one or more sensors are configured to measure one or more forces applied to the at least one assistive device by the individual.

5. The assessment system of claim 1, wherein the one or more aspects of transfer performance represented by the sensor data comprises one or more of gait, stability, location, movement, grip force, and grip type of the individual.

6. The assessment system of claim 1, wherein the one or more sensors comprise one or more of a load cell, a force sensing resistor, a capacitive sensor, a motion sensor, a touch sensor, a camera linear potentiometer, location sensors, pressure mapping sensor, presence sensor, camera depth sensor, radar speed sensor, depth sensor, radar 3D imaging sensor, multi-camera depth sensor, and stereo depth sensor.

7. The assessment system of claim 1, wherein the one or more sensors are embedded in the at least one assistive device.

8. The assessment system of claim 2, wherein the at least one assistive device comprises an adjustable grab bar, the adjustable grab bar being configured to slide between the first position and the second position in the bathroom environment.

9. The assessment system of claim 1, wherein the at least one assistive device comprises an adjustable toilet that is configured to be raised and lowered when moving from the first position to the second position or from the second position to the first position.

10. The assessment system of claim 2, wherein the recommended adjustment comprises a height adjustment of the at least one assistive device.

11. The assessment system of claim 1, wherein the at least one assistive device comprises a plurality of assistive devices, each of the assistive devices of the plurality of assistive devices comprise at least one of the one or more sensors.

12. The assessment system of claim 11, wherein the plurality of assistive devices comprises two or more of a grab bar, a toilet, a movable toilet, a toilet seat, a bath tub, a shower seat, or a wall.

13. An adjustable bathroom environment, comprising
at least one assistive device configured to assist an individual with toilet or bathing transfer in a bathroom environment, the at least one assistive device being configured to be movable within the bathroom environment;
one or more of a toilet transfer system, a bathing transfer system, and a floor transfer system under the toilet and bathing transfer systems, each of the toilet transfer system, the bathing transfer system, and the floor transfer system comprising one or more sensors, the one or more sensors being configured to measure and collect sensor data during stages of the toilet or bathing transfer by the individual using the at least one assistive device, wherein the sensor data represents one or more aspects of transfer performance of the individual;
a control module comprising an assistive technology computing device communicatively coupled with the one or more sensors, the control module being programmed with computer readable instructions that, when executed, cause the control module to:
receive the sensor data from the one or more sensors,
assess a transfer performance of the individual based on the sensor data, and
provide a recommended adjustment in connection with the at least one assistive device needed for the bathroom environment based on the transfer performance of the individual assessed by the control module, the recommended adjustment being one or both of:
(a) adjusting a position of the at least one assistive device by moving the at least one assistive device from a first position in the bathroom environment to a second position in the bathroom environment, or
(b) adding another assistive device to the bathroom environment.

14. The adjustable bathroom environment of claim 13, wherein the control module is located outside of the adjustable bathroom environment, and the control module is in wireless communication with the one or more sensors.

15. The adjustable bathroom environment of claim 13, wherein the control module is in communication with a user's device which is in communication with the one or more sensors.

16. The adjustable bathroom environment of claim 13, wherein the at least one assistive device comprises a grab bar, a movable toilet, a toilet seat, a bath tub, a shower seat, or a wall.

17. The adjustable bathroom environment of claim 13, wherein the one or more sensors comprise one or more of a load cell, a force sensing resistor, a capacitive sensor, a motion sensor, a touch sensor, a camera linear potentiometer, location sensors, pressure mapping sensor, presence sensor, camera depth sensor, radar speed sensor, depth sensor, radar 3D imaging sensor, multi-camera depth sensor, and stereo depth sensor.

18. A method for assessing transfer performance of an individual in a bathroom environment, comprising:
collecting sensor data associated with at least one assistive device in the bathroom environment during stages of toilet or bathing transfer by the individual in the bathroom environment, wherein the sensor data represents one or more aspects of transfer performance of the individual;
transmitting the sensor data to a control module comprising an assistive technology computing device, the control module being programmed with computer readable instructions that, when executed, cause the control module to assess a transfer performance of the individual based on the sensor data and recommend an adjustment in connection with the at least one assistive device needed for the bathroom environment based on the transfer performance of the individual assessed by the control module; and
based the adjustment recommended by the control module, either or both of:
(a) adjusting a position of the at least one assistive device by moving the at least one assistive device from a first position in the bathroom environment to a second position in the bathroom environment, or
(b) adding another assistive device to the bathroom environment.

19. The method of claim 18, wherein the at least one assistive device comprises a grab bar, a movable toilet, a toilet seat, a bath tub, a shower seat, or a wall.

20. The method of claim 18, wherein one or more sensors are associated with the at least one assistive device, and the one or more sensors are configured to measure and collect the sensor data.

21. The method of claim 20, wherein the one or more sensors comprise one or more of a load cell, a force sensing resistor, a capacitive sensor, a motion sensor, a touch sensor, a camera linear potentiometer, location sensors, pressure mapping sensor, presence sensor, camera depth sensor, radar speed sensor, depth sensor, radar 3D imaging sensor, multi-camera depth sensor, and stereo depth sensor.

22. The method of claim 18, wherein the one or more aspects of transfer performance represented by the sensor data comprises one or more of gait, stability, location, movement, grip force, and grip type of the individual.
